(19) United States
(12) Patent Application Publication
(10) Pub. No.: US 2005/0228692 A1
(43) Pub. Date: Oct. 13, 2005

(54) Incentive based health care insurance program

(76) Inventor: Darren W. Hodgdon, Lake Forest, IL (US)

Correspondence Address: MAYER, BROWN, ROWE & MAW LLP, P.O. BOX 2828, CHICAGO, IL, 60690-2828, US

(21) Appl. No.: 10/821,084

(22) Filed: Apr. 8, 2004

(51) Int. Cl. G06F 17/60

(52) U.S. Cl. 705/2

(57) ABSTRACT

Apparatuses, systems, programs, and/or methods of administering an incentive health care insurance program are provided. In one aspect, the apparatuses, systems, programs, and/or methods comprise offering one or more incentives to a participant of a health care insurance program to complete a health risk assessment questionnaire or a biometric measurement analysis, and/or to provide a biosample for biomedical analysis; scoring, ranking, and/or grading the health risk assessment and/or the biometric parameters for one or more health risks; analyzing the biosample for one or more biomedical parameters; analyzing the scored, ranked, and/or graded health risk assessment questionnaire and/or the biometric parameters, and/or biomedical parameters and determining a Health Score to assess for presence or risk of disease; and optionally providing one or more additional incentives to the one or more participants to achieve, maintain, or improve their Health Score and/or an individual parameter of a Health Score.

### FIELD OF INVENTION

This invention relates to apparatuses, systems, programs, and/or methods for providing incentives and/or motivation to participate in an incentive based health care insurance program.

### BACKGROUND OF THE INVENTION

There remains a need for health care insurance sponsors to transition away from costly indemnity based health care plans to more flexible and/or modified plan structures that reduce cost of the plan. As participants of such plans desire more control over their health care decisions and health care insurance sponsors pass along more financial and administrative responsibility to their participants, both need reliable and easy to manage information. It is also desirable to provide statistical analysis to health care insurance sponsors so they can better forecast future claims and proactively manage risk before having to treat illness of the participants. Additionally, it is also desirable to provide participants with information to understand their health and well being; information that may not be readily available from their doctors; and information that leads to improved behaviors and lower annual claims costs. Furthermore, it is desirable to have a healthier more productive workforce and/or improved financial performance for employees.

Therefore, there is a need for incentive based health care insurance systems or programs that offer incentives and motivation to individuals to encourage more active participation in their health care. Lowering or reducing health care costs and lowering or reducing health care insurance costs, claims, and deductibles are also desired, as well as educating individuals about their health, disease risks and modifiable risk factors. The discussion that follows discloses incentive based health care insurance apparatuses, methods, programs, and/or systems that help to fulfill these needs.

### SUMMARY OF THE INVENTION

The present invention is directed to apparatuses, methods, programs, and/or systems for administering an incentive based insurance plan, method, system, and/or program. In one aspect of the present invention, a method of administering an incentive based health care program is provided that comprises offering one or more incentives to a participant of the health care program. The incentives are directed towards the performing at least one of completing a health risk assessment questionnaire addressing one or more health risks, providing a biosample, for example, a blood, tissue, organ, saliva, hair, skin, fingernail, toenail, urine, and/or stool sample for biomedical analysis and/or completing a biometric measurement analysis. In one embodiment, if the participant completes the health risk assessment questionnaire, completes the biometric measurement analysis, and/or provides the biosample, the incentive is given to the one or more participants. If the biosample is provided the sample is analyzed for one or more biomedical parameters.

In one aspect of the invention, the results of the health risk assessment questionnaire, biometric analysis, and/or the biosample are then evaluated, scored, ranked and/or graded for one or more health risks and a Health Score is calculated, assigned, and/or determined. Illustratively, a Health Score can be calculated, assigned, and/or determined by first determining a value (for example, a numerical or an alphabetical value) associated with a particular health risk using, for example, nationally recognized data. The participant and/or sponsor of the health care program are then notified of the score. Additional incentives can be provided to the participants to achieve, maintain and/or improve a Health Score. In another aspect of the present invention, the apparatuses, systems, programs, and/or methods are computer augmented and/or implemented.

### BRIEF DESCRIPTION OF THE DRAWINGS

FIG. 1 is a flowchart illustrating a qualifying Health Insurance Portability and Accountability Act bona fide wellness program in which incentives are provided to a program participant to complete a health risk assessment questionnaire, provide a biosample for biomedical analysis and/or complete a biometric measurement analysis.

FIG. 2 is a flowchart illustrating a data management scheme where data from a participant are entered from a website.

FIG. 3 is a flowchart illustrating a data management scheme where data from a participant generated from laboratory analysis are parsed and then entered into a health risk assessment database, where they are scored, ranked, and/or graded to produce a Health Score.

FIG. 4 is a flowchart illustrating a data management scheme where data from participant that are entered into a Scantron® are entered into a data management program such as Excel® and then entered into a health risk assessment database, where they are scored, ranked, and/or graded to produce a Health Score.

### DETAILED DESCRIPTION OF THE INVENTION

The present invention is directed to apparatuses, methods, programs, and/or systems for administering an incentive based insurance plan, method, system, and/or program. Illustratively, the incentive based insurance plan is directed to lowering health care insurance claim payouts, altering behavior of health care insurance participants, providing incentives and incentive information to health care insurance participants, providing an incentive plan to a business or organization in connection with a health care insurance plan, and/or encouraging participation in an incentive based insurance program. In one embodiment of the present invention, the apparatuses, systems, programs, and/or methods are computer augmented and/or implemented.

While the present invention may be embodied in many different forms, several specific embodiments are discussed herein with the understanding that the present disclosure is to be considered only an exemplification of the principles of the invention, and it is not intended to limit the invention to the embodiments illustrated.

Instead of passing increased healthcare costs along to insurance participants, the present invention provides incentives and clinical health information to encourage and/or motivate behavioral change and/or increase good-health consciousness in the participants. A number of chronic health conditions such as, for example, asthma, cholesterolemia, depression, hypertension, coronary heart disease, diabetes, and/or lower back pain can be managed by medical treatment and/or positive lifestyle changes. However, before insurance participants can be expected to manage their healthcare needs or the needs for their family, they must first understand how to assess their own health. In one embodiment of the present invention, an incentive based program is provided to a participant at a convenient location to the participant (for example, the workplace). The program is a means of encouraging insurance participants through incentives to partake in a health survey and/or to maintain or improve the participant's health over time resulting in lower health claim costs as a result of improved health. The program delivers value to those that share the costs of a participant's healthcare insurance by, for example, lowering the participant's health claims; educating the participant about modifiable risk factors; scoring, ranking, and/or grading the participant for modifiable risk factors; improving health scores; and/or tying health scores to incentives such as, for example, contribution rate discounts and/or deductibles.

The apparatuses, methods, programs, and/or systems of the present invention can also promote preventive health care by providing health risk assessment tools to employers, employees, individuals, and/or participants.

In one aspect of the present invention, a method of administering an incentive based health care program is provided. The method comprises offering one or more incentives to a participant of the health care program, with the one or more incentives provided to the participants to perform at least one of completing a health risk assessment questionnaire addressing one or more health risks, providing a blood, tissue, organ, saliva, hair, skin, fingernail, toenail, urine, and/or stool sample (a “biosample”) for biomedical analysis, and/or completing a biometric measurement analysis. When the one or more participants completes the health risk assessment questionnaire and/or provides the biosample, the incentive is given to the one or more participants; and if the biosample is provided the biosample is analyzed for one or more biomedical parameters. The results of the health risk assessment questionnaire, biometric data, and/or the biosample are then evaluated for one of the one or more health risks and a Health Score is calculated. The participant and/or sponsor of the health care program are then notified of the score. Additional incentives can be provided to the participants to achieve, maintain and/or improve a Health Score. In another aspect of the present invention, the apparatuses, systems, programs, and/or methods are computer augmented and/or implemented.

In yet another aspect of the present invention, the method comprises calculating incentive information in accordance with an incentive program. For example, in one embodiment, the incentive program bases the incentive information on the Health Score of the participant, and/or on a comparison of a medical index of normal range with a health risk, a biometric parameter, and/or a biomedical parameter. The incentive program can also provide for incentives for improving a Health Score over a period of time, maintaining a predetermined Health Score over a period of time, partaking in the incentive program at a future point in time, and/or improving an individual health parameter, such as, for example, quitting smoking, lowering alcohol consumption, implementing a healthy dietary change, implementing an exercise program, and/or improving serum cholesterol and triglyceride levels or ratios and/or a hemoglobin A1c score. Incentives can include such things as, for example, a financial or monetary reward, merchandise, a coupon, a voucher, a prize, a ticket to an entertainment or sporting event, a travel award, accruing vacation or time off from work, a discount on a good or service, a membership discount, a contribution discount, a lower deductible as compared to non-participants, or a credit to a health spending account linked to the participant's health care insurance plan. Additionally, the Health Score of a participant can be based on a comparison to a medical index of normal range for a health risk, a biometric parameter, and/or a biomedical parameter. Further, a health risk, a biometric parameter, and/or a biomedical parameter can be evaluated in comparison to a medical index of normal range to determine the Health Score. The health risks, the biometric parameters, and/or the biomedical parameters may also be scored based on the impact on excess health care claim. Illustratively, a health risk, a biometric parameter, and/or a biomedical parameter can include, for example, tobacco use, blood pressure, body weight, body-mass-index, body fat, total cholesterol level, high density cholesterol level, ratio of total cholesterol level to high density cholesterol level, low density cholesterol level, triglyceride level, glucose level, or gamma glutamyltransferase level. The health risks, the biometric parameters, and/or the biomedical parameters can also be modifiable by the one or more participants within a period of time, for example, less than about twelve months or so, by at least one of administration of a pharmacological agent, gene therapy, implementation of a behavioral change, implementation of an exercise regime, and/or implementation of a dietary change. Illustratively, broad classes of pharmacological agents useful in the present invention include, for example, a prescription drug, an over-the-counter drug, a homeopathic agent, an herbal agent, a mineral, and/or a vitamin. A behavioral change can include, for example, quitting smoking or use of tobacco, implementing an exercise program, while a dietary change can include, for example, consuming food that is either higher or lower depending on the condition of the participant in at least one of salt, calories, carbohydrates, protein, fat, cholesterol, and/or triglycerides.

In another aspect of the present invention, a biomedical parameter used to determine a Health Score assesses vital organ function, including, for example, serum concentration of at least one of glucose, blood urea nitrogen, creatinine, uric acid, bilirubin, serum glutamic-oxaloacetic transaminase enzyme, serum glutamate pyruvate transaminase enzyme, alkaline phosphatase, lactic acid dehydrogenase, total protein, albumin, globulin, iron, calcium, phosphorous, sodium, potassium, chloride, high density lipoprotein, triglycerides, total cholesterol, very low density lipoprotein, and/or low density lipoprotein. Therapeutic ratios can also be calculated, including, for example, albumin/globulin ratio, total cholesterol/high density lipoprotein ratio, and/or low density lipoprotein/high density lipoprotein ratio.

One or more additional incentives can also be provided to the one or more participants to achieve, maintain or improve their Health Score over a period of time. Other items or information such as, for example, a self-care handbook, a web page or website, a pamphlet, and/or a book comprising information regarding at least one of homeopathic care, self-awareness, preventive care, or medical alert, can also be provided to a participant for participating in a health care program, including, for example, completing a health risk assessment questionnaire, completing a biometric measurement analysis, and/or for providing a biosample for biomedical analysis. A report of the biometric parameters and/or biomedical parameters determined from the biosample can also be provided to the participant and/or sponsor. Such biometric and/or biomedical parameters can also be compared to a medical index of normal range.

In another aspect of the present invention, a health risk, a biometric parameter, and/or a biometric parameter is reported to a participant of a method, program, and/or system of the present invention numerically, graphically, verbally, telephonically, electronically, and/or textually. Additionally, a participant can be alerted when a health risk, a biometric parameter, and/or a biomedical parameter falls outside a medical index of normal range. A participant can also be informed in another embodiment of the present invention, when one or more health risks associated with the health risk, the biometric parameter, and/or the biomedical parameter falls outside the medical index of normal range; that it is advisable to counsel one or more physicians regarding a health risk, a biometric parameter, and/or a biomedical parameter that falls outside the medical index of normal range; that one or more tests are available that can be used to determine the cause of the health risk, the biometric parameter, and/or the biomedical parameter falling outside the medical index of normal range; that one or more tests are available that can be used to determine treatment for the health risk, the biometric parameter, and/or the biomedical parameter falling outside the medical index of normal range; that there are one or more pharmacological agents that can assist in bringing the health risk, the biometric parameter, and/or the biomedical parameter falling outside the medical index of normal range substantially into normal range; that one or more behavioral changes can assist in bringing the health risk, the biometric parameter, and/or the biomedical parameter falling outside the medical index of normal range substantially into normal range; and/or that one or more dietary changes can assist in bringing the health risk, the biometric parameter, and/or the biomedical parameter falling outside the medical index of normal range substantially into normal range. Regarding a health risk or the biometric parameter that falls outside the medical index of normal range, the participant can also be offered in yet another embodiment of the present invention, at least one of a doctor prescribed prescription medication or pharmacological agent, a doctor prescribed prescription to a medication or a pharmacological agent, an over-the-counter drug or pharmacological agent, a homeopathic agent, an herbal agent, a mineral, a vitamin, information pertaining to an exercise program, a lifestyle regimen, and/or a dietary program, and/or information regarding health effects of the health risk, the biometric parameter, and/or the biomedical parameter that falls outside the medical index of normal range. The health risk, the biometric parameter, and/or biomedical parameter can also be explained to a participant in relation to the participant's health and/or relevance to a health-risk behavior.

Incentives can also be provided in another aspect of the present invention to improve a Health Score by consuming items that are lower or higher in at least one of salt, calories, carbohydrates, protein, fat, cholesterol, or triglycerides.

In another aspect of the present invention, the step of completing the health risk assessment questionnaire, completing a biometric measurement analysis, and/or providing a biosample for biomedical analysis is for categorizing the participant under assessment for purposes of suggesting a type of therapeutic treatment (for example, a pharmacological agent, exercise program, and/or dietary change) on the basis of the health risks results, the biometric parameters results, and/or biomedical results.

The apparatuses, systems, programs, and/or methods of the present invention can also be accessed in one embodiment of the present invention over the Internet. A means of communicating may also be implemented via a network that is configured to interface over the Internet between the one or more participants and the health care program.

In another aspect of the present invention, a participant authorizes the used of his or her test results and/or Health Score to, for example, a manager of the health care program, or an affiliate or subcontractor thereof. Such authorization in one embodiment is in the form of a consent clause or form provided to the participant for signature before, during, and/or after the participant agrees to partake in a health care program of the present invention. Illustratively, the information collected in conjunction with the health care program can be used to generate a report and/or a comparison to, for example, assess the efficacy of the health care program and/or develop health care cost containment strategies. A manager of the health care program, a sponsor of the health care program, a benefit broker, a consultant, and/or an industry publication can further use this information to, for example, better manage the health care program, research purposes, and/or send informational material to the participants of the health care program. Such reports and/or comparisons can be generated at any time necessary to accomplish such objectives, and include for example, a group report, a daily report, a weekly report, a monthly report, a bimonthly report, a quarterly report, a biannual report, an annual report, a group comparison, a daily comparison, a weekly comparison, a monthly comparison, a bimonthly comparison, a quarterly comparison, a biannual comparison, and/or an annual comparison. In one embodiment the reports or comparisons comprise aggregate information, and may or may not contain data that can identify an individual participant.

In yet another aspect of the present invention, the information collected from a participant in conjunction with a health care program is communicated to a coach and/or a health care practitioner to, for example, assist the participant in, for example, achieving, maintaining, and/or improving a Health Score; to assist in monitoring the health of the participant; and/or to assist in instructing the participant in regard to the information. In one embodiment, the information communicated to the coach or health care practitioner is done with consent of the participant. Illustratively, a health care practitioner can include a nurse, a medical doctor's assistant, a medical doctor, a chiropractor, a psychologist, a social worker, a psychiatrist, a physical therapist, a massage therapist, a acupuncturist, a dietitian, and/or a physical trainer.

In another aspect of the present invention, a computer program product for use with a system for managing an incentive based health care program is provided. The product comprises a computer usable medium having program code embodied in the medium for causing the computer program to interface over a communications medium between a sponsor of the health care program and one or more participants of the health care program, wherein the program code offers to the one or more participants a health risk assessment questionnaire addressing one or more health risks, recognizes analyzed or raw data from one or more biometric analyses, and/or recognizes analyzed or raw data from one or more biomedical analyses obtained from a biosample received from the one or more participants; evaluates at least one of the one or more health risks, the one or more biometric parameters, and/or the one or more biomedical parameters to calculate a Health Score to assess for presence or risk of disease; and notifies the one or more participants (or, with consent of the participant, the sponsor of the incentive program and/or an entity involved in the management or operation of the incentive program) of the Health Score. The program code may further access a database to determine an incentive based on the Health Score of the participant.

The phrase “health assessment tools” as used herein may include health assessment surveys, and can be provided to participants, in one embodiment of the present invention, online, telephonically, or in paper form to collect and assess health-related histories, behaviors, and/or current health status. Biometric and/or biomedical (“biomarkers”) measurements and specimens can also be collected for the purpose in another embodiment of the present invention of monitoring modifiable health risk factors. Such modifiable health risk factors include, for example, those that an individual can modify within a period of time, for example, less than about twelve months or so, by at least one of administration of a pharmacological agent to or by the participant, gene therapy, implementation of a behavioral change, implementation of an exercise regime, or implementation of a dietary change. Biomarkers may also be scored to signify their relevance to health care claims, with, for example, low scores in one embodiment correlating with higher health claims, or alternatively, low scores correlating with lower health claims. Participation in the apparatuses, systems, programs, and/or methods of the present invention can be incentivized in various ways for participation including offering preferential health care plans, premiums, and/or deductibles to those who chose to participate.

The phrase “Health Score” as used herein refers to the scoring, ranking, and/or grading of one or more test results used to quantify and/or qualify the health status of an individual. Such test results can include, for example, one or more individual parameters of a self-reported health risk questionnaire, a biomedical result from a biosample test, and/or a biometric measurement, such as, for example, height, weight, neck, waist and hip measurements, and/or blood pressure. Further, these test results can be used in conjunction with a score to trigger incentives tied to a health plan as described herein. Illustratively, a Health Score can be calculated or established by first determining a value (for example, a numerical or an alphabetical value) associated with a health risk by using, for example, nationally recognized data. For example, on a scale from 0 to 100, an increasing score from 0 to 100 indicates a lower health risk for that particular parameter. In one embodiment, high density lipoprotein cholesterol levels of a score of 50 or more is assigned a value of 100 points indicating minimal health risk; a score of 45-59 is assigned a value of 75 points indicating a moderate health risk; a score of 40-44 is assigned a value of 50 points indicating a medium health risk; a score of 35-39 is assigned a value of 25 points indicating a high health risk; and a score of 34 or below is assigned a value of 0 points indicating an extreme health risk. Other parameters and health risks can also be similarly assigned values based on the health risk associated with a particular test result. When there are more than one health parameter, each parameter can be weighted based on the impact of the particular parameter on, for example, the health impact on a participant, excess medical costs due to excess health risk, cost savings associated with lowing the incidence of the health risk, medical and pharmacy costs in treating a particular health parameter, and/or worker's compensation, short-term compensation, and absenteeism associated with the health parameter. For example, if it is determined that two parameters have equal weight, each in a 100 point scale would be assigned a total value of 50. The points achieved from the two parameters would be added to determine a composite Health Score. As explained herein, incentives can also be tied to achieving, improving, and/or maintaining a Health Score. For example, an incentive can be provided for a participant to increase his or her Health Score from 0 to 25, 25 to 50, 50 to 75, or 75 to 100; or to initially achieve a predetermined Health Score such as, for example, a score of 100 or to maintain it over a period of time and/or testing periods. In the above example, an incentive could be awarded to a participant by, for example, the participant increasing his or her high density lipoprotein cholesterol reading from 34 or below to between 35 to 39, or from a reading of between 35 to 39 to between 40 to 44, or from a reading of between 40 to 44 to between 45 to 59, or from a reading of between 45 to 59 to 50 or above.

The term “contribution” as used herein refers to the percentage participant's pay of his or her insurance premium. In context of a “contribution discount,” a Health Score can translate into a discount if the Health Score improves from test to test, is equal to or better than a predetermined score, or if the participant submits written verification from a physician that one or more risk factors negatively impacting their Health Score are being treated and/or the participant is complying with prescribed care including, for example, taking drugs, exercising, and/or dieting.

The phrase “medical index of normal range” as used herein refers nationally published data for a particular health parameter, including, for example, data published by the American Medical Association, the American Heart Association, the American Diabetes Association, or the National Institute of Health.

The phrase “cardiovascular disease” or “cardiovascular disorder” as used herein generally refers to any cardiovascular disease and/or disorder, or the symptoms associated with the disease or disorder, including, for example, restenosis, atherosclerosis, atherogenesis, angina (particularly chronic, stable angina pectoris), ischemic disease, congestive heart failure, pulmonary edema associated with acute myocardial infarction, thrombosis, controlling blood pressure in hypertension (for example, hypertension associated with cardiovascular surgical procedures), platelet aggregation, platelet adhesion, smooth muscle cell proliferation, vascular complications associated with the use of medical devices, wounds associated with the use of medical devices, and the like. Complications associated with the use of medical devices may occur as a result of increased platelet deposition, activation, thrombus formation or consumption of platelets and coagulation proteins. Such complications, which are within the definition of “cardiovascular disease and/or disorder,” include, for example, myocardial infarction, pulmonary thromboembolism, cerebral thromboembolism, thrombophlebitis, thrombocytopenia, bleeding disorders and/or any other complications which occur either directly or indirectly as a result of the foregoing disorders.

The term “restenosis” as used herein generally refers to a cardiovascular disease and/or disorder that refers to the closure of a peripheral or coronary artery following trauma to the artery caused by an injury such as, for example, angioplasty, balloon dilation, atherectomy, laser ablation treatment or stent insertion. For these angioplasty procedures, restenosis occurs at a rate of about 30-60% depending upon the vessel location, lesion length and a number of other variables. Restenosis can also occur following a number of invasive surgical techniques, such as, for example, transplant surgery, vein grafting, coronary artery bypass surgery, endarterectomy, heart transplantation, balloon angioplasty, atherectomy, laser ablation, endovascular stenting, and the like.

The term “atherosclerosis” as used herein generally refers to a form of chronic vascular injury in which some of the normal vascular smooth muscle cells in the artery wall, which ordinarily control vascular tone regulating blood flow, change their nature and develop abnormal behavior. These vascular smooth muscle cells become abnormally proliferative, secreting substances such as growth factors, tissue-degradation enzymes and/or other proteins, which enable them to invade and spread into the inner vessel lining, blocking blood flow and making that vessel abnormally susceptible to being completely blocked by local blood clotting, resulting in the death of the tissue served by that artery.

The phrase “inflammatory disease” as used herein generally refers to any inflammatory disease and/or disorder or a symptom associated with the disease or disorder, whether of a chronic or acute nature, including, for example, rheumatoid arthritis, inflammatory skin diseases, such as, psoriasis and eczema, restenosis, multiple sclerosis, surgical adhesion, tuberculosis, inflammatory lung diseases such as, asthma, pneumoconiosis, chronic obstructive pulmonary disease, nasal polyps and pulmonary fibrosis, inflammatory bowel disease, such as, Crohn's disease and ulcerative colitis, graft rejections, inflammatory diseases that affect or cause obstruction of a body passageway, such as, vasculitis, Wegener's granulomatosis and Kawasaki disease, systemic lupus erthematosus, inflammation of the eye, nose or throat, such as, neovascular diseases of the eye including neovascular glaucoma, proliferative diabetic retinopathy, retrolental fibroblasia, mascular degeneration, reduction of intraocular pressure, corneal neovascularization, such as, corneal infections, immunological processes, such as, graft rejection and Steven-Johnson's syndrome, alkali burns, trauma and inflammation (of any cause).

The term “cancer” as used herein refers to all types of cancer or neoplasm or malignant tumors found in mammals, including, for example, carcinomas and sarcomas. Examples of cancers include cancer of the brain, breast, pancreas, cervix, colon, head and neck, kidney, lung, non-small cell lung, melanoma, mesothelioma, ovary, sarcoma, stomach, uterus, and Medulloblastoma.

The term “carcinoma” as used herein generally refers to a malignant new growth made up of epithelial cells tending to infiltrate the surrounding tissues and give rise to metastases. Exemplary carcinomas include acinar carcinoma, acinous carcinoma, adenocystic carcinoma, adenoid cystic carcinoma, carcinoma adenomatosum, carcinoma of adrenal cortex, alveolar carcinoma, alveolar cell carcinoma, basal cell carcinoma, carcinoma basocellulare, basaloid carcinoma, basosquamous cell carcinoma, bronchioalveolar carcinoma, bronchiolar carcinoma, bronchogenic carcinoma, cerebriform carcinoma, cholangiocellular carcinoma, chorionic carcinoma, colloid carcinoma, comedo carcinoma, corpus carcinoma, cribriform carcinoma, carcinoma en cuirasse, carcinoma cutaneum, cylindrical carcinoma, cylindrical cell carcinoma, duct carcinoma, carcinoma durum, embryonal carcinoma, encephaloid carcinoma, epiermoid carcinoma, carcinoma epitheliale adenoides, exophytic carcinoma, carcinoma ex ulcere, carcinoma fibrosum, gelatiniform carcinoma, gelatinous carcinoma, giant cell carcinoma, carcinoma gigantocellulare, glandular carcinoma, granulosa cell carcinoma, hair-matrix carcinoma, hematoid carcinoma, hepatocellular carcinoma, Hurthle cell carcinoma, hyaline carcinoma, hypemephroid carcinoma, infantile embryonal carcinoma, carcinoma in situ, intraepidermal carcinoma, intraepithelial carcinoma, Krompecher's carcinoma, Kulchitzky-cell carcinoma, large-cell carcinoma, lenticular carcinoma, carcinoma lenticulare, lipomatous carcinoma, lymphoepithelial carcinoma, carcinoma medullare, medullary carcinoma, melanotic carcinoma, carcinoma molle, mucinous carcinoma, carcinoma muciparum, carcinoma mucocellulare, mucoepidermoid carcinoma, carcinoma mucosum, mucous carcinoma, carcinoma myxomatodes, nasopharyngeal carcinoma, oat cell carcinoma, carcinoma ossificans, osteoid carcinoma, papillary carcinoma, periportal carcinoma, preinvasive carcinoma, prickle cell carcinoma, pultaceous carcinoma, renal cell carcinoma of kidney, reserve cell carcinoma, carcinoma sarcomatodes, schneiderian carcinoma, scirrhous carcinoma, carcinoma scroti, signet-ring cell carcinoma, carcinoma simplex, small-cell carcinoma, solanoid carcinoma, spheroidal cell carcinoma, spindle cell carcinoma, carcinoma spongiosum, squamous carcinoma, squamous cell carcinoma, string carcinoma, carcinoma telangiectaticum, carcinoma telangiectodes, transitional cell carcinoma, carcinoma tuberosum, tuberous carcinoma, verrucous carcinoma, and carcinoma villosum. Other cancers include, for example, Hodgkin's Disease, Non-Hodgkin's Lymphoma, multiple myeloma, neuroblastoma, breast cancer, ovarian cancer, lung cancer, rhabdomyosarcoma, primary thrombocytosis, primary macroglobulinemia, small-cell lung tumors, primary brain tumors, stomach cancer, colon cancer, malignant pancreatic insulanoma, malignant carcinoid, urinary bladder cancer, premalignant skin lesions, testicular cancer, lymphomas, thyroid cancer, neuroblastoma, esophageal cancer, genitourinary tract cancer, malignant hypercalcemia, cervical cancer, endometrial cancer, adrenal cortical cancer, and prostate cancer.

The term “sarcoma” as used herein generally refers to a tumor which is made up of a substance like the embryonic connective tissue and is generally composed of closely packed cells embedded in a fibrillar or homogeneous substance. Illustratively, a sarcoma includes a chondrosarcoma, fibrosarcoma, lymphosarcoma, melanosarcoma, myxosarcoma, osteosarcoma, Abemethy's sarcoma, adipose sarcoma, liposarcoma, alveolar soft part sarcoma, ameloblastic sarcoma, botryoid sarcoma, chloroma sarcoma, chorio carcinoma, embryonal sarcoma, Wilms' tumor sarcoma, endometrial sarcoma, stromal sarcoma, Ewing's sarcoma, fascial sarcoma, fibroblastic sarcoma, giant cell sarcoma, granulocytic sarcoma, Hodgkin's sarcoma, idiopathic multiple pigmented hemorrhagic sarcoma, immunoblastic sarcoma of B cells, lymphoma, immunoblastic sarcoma of T-cells, Jensen's sarcoma, Kaposi's sarcoma, Kupffer cell sarcoma, angiosarcoma, leukosarcoma, malignant mesenchymoma sarcoma, parosteal sarcoma, reticulocytic sarcoma, Rous sarcoma, serocystic sarcoma, synovial sarcoma, and telangiectaltic sarcoma.

The term “melanoma” as used herein generally refers to a tumor arising from the melanocytic system of the skin and other organs. Illustratively, melanomas include acral-lentiginous melanoma, amelanotic melanoma, benign juvenile melanoma, Cloudman's melanoma, S91 melanoma, Harding-Passey melanoma, juvenile melanoma, lentigo maligna melanoma, malignant melanoma, nodular melanoma, subungal melanoma, and superficial spreading melanoma.

The term “leukemia” as used herein generally refers broadly to progressive, malignant diseases of the blood-forming organs and is generally characterized by a distorted proliferation and development of leukocytes and their precursors in the blood and bone marrow. Leukemia is generally clinically classified on the basis of (1) the duration and character of the disease-acute or chronic; (2) the type of cell involved; myeloid (myelogenous), lymphoid (lymphogenous), or monocytic; and (3) the increase or non-increase in the number abnormal cells in the blood-leukemic or aleukemic (subleukemic). Illustratively, a leukemia includes acute nonlymphocytic leukemia, chronic lymphocytic leukemia, acute granulocytic leukemia, chronic granulocytic leukemia, acute promyelocytic leukemia, adult T-cell leukemia, aleukemic leukemia, a leukocythemic leukemia, basophylic leukemia, blast cell leukemia, bovine leukemia, chronic myelocytic leukemia, leukemia cutis, embryonal leukemia, eosinophilic leukemia, Gross' leukemia, hairy-cell leukemia, hemoblastic leukemia, hemocytoblastic leukemia, histiocytic leukemia, stem cell leukemia, acute monocytic leukemia, leukopenic leukemia, lymphatic leukemia, lymphoblastic leukemia, lymphocytic leukemia, lymphogenous leukemia, lymphoid leukemia, lymphosarcoma cell leukemia, mast cell leukemia, megakaryocytic leukemia, micromyeloblastic leukemia, monocytic leukemia, myeloblastic leukemia, myelocytic leukemia, myeloid granulocytic leukemia, myelomonocytic leukemia, Naegeli leukemia, plasma cell leukemia, plasmacytic leukemia, promyelocytic leukemia, Rieder cell leukemia, Schilling's leukemia, stem cell leukemia, subleukemic leukemia, and undifferentiated cell leukemia.

The phrase “gene therapy” as used herein generally refers to human gene therapy that introduces a functionally active “replacement” gene into a somatic cell of an individual to correct a gene defect. Illustratively, retroviral vectors, because of their unique structure, modes of replication, and ability to infect a wide variety of cells, including stem cells, can be used to transfer genetic material into somatic cells. Additionally, to ensure an extended supply of the replacement gene product over time, in one embodiment of the present invention, the functionally active gene can be introduced and expressed in cells that proliferate during the adult life of the recipient. Illustratively, because pluripotent stem cells in bone marrow have both self-renewal capacity as well as the ability to give rise to all hematopoietic lineages, they are a popular target for the introduction of functionally active genes. Additionally, for example, hepatocytes and/or fibroblasts (for example, keratinocytes) can also be used as target cells for introducing functionally active genes. Other types of cells for introduction of active genes are known to those skilled in the art, see, for example, U.S. Pat. No. 6,316,416.

The term “pharmacological agent” as used herein generally refers to a drug or other biologically active substance or compound to treat, prevent, and/or lower the risk of developing a disease and/or a condition, or a symptom associated with the disease or condition (also termed “pharmacotherapy”). Illustratively, a pharmacological agent can include an abortifacient, an ace-inhibitor, an agonist, an alpha-andrenergic agonist, a beta-andrenergic agonist, an alpha-andrenergic blocker, a beta-andrenergic blocker, an amino acid, an andrenocortical steroid, an andrenocortical suppressant, an andrenocorticotropic hormone, an alcohol deterrent, an aldose reductase inhibitor, an aldosterone antagonist, a 5-alpha reductase inhibitor, an anabolic, an analeptic, an analgesic (for example, dental, narcotic, non-narcotic), an androgen, an anesthetic (for example, inhalation, intravenous, local), an angiotensin converting enzyme inhibitor, an angiotensin II receptor antagonist, an anorexic, an antacid, an antagonist, an anthelmintic (for example, cestodes, nematodes, schistosoma, trematodes), an antiacne agent, an antiallergic (for example, hyposensitization therapy, steroidal, nasal), an antialopecia agent, an antiamebic, an antiadrenergic agent, an antiandrogen, an antianginal, an antiarrythmic, an antiarterioscerotic, an antiarthritic, an antirheumatic, an antiatherosclerotic, an antiasthmatic (for example, nonbronchodilator, steroidal, inhalant), an antibacterial, an antibiotic, an antibacterial adjunct, an anticancer, an anticholelithogenic, an anticholesteremic, an anticholinergic, an anticoagulant, an anticonvulsant, an antidepressant, an antidiabetic, an antidiarrheal, an antidiuretic, an antidote (for example, acetaminophen poisoning, curare, cyanide, folic acid antagonist, heavy metal poisoning, methanol poisoning, ethylene glycol poisoning, organophosphate poisoning), an antidyskinetic, an antieczematic, an antiemetic, an antiepileptic, an antiestrogen, an antifibrotic, an antiflatulent, an antifungal, an antiglaucoma, an antigonadotropin, an antigout, an antihemorrhagic, an antihistaminic, an antihypercholesterolemic, an antihyperlipidemic, an antihyperlipoproteinemic, an antihyperphosphatemic, an antihypertensive, an antihyperthyroid, an antihypotensive, an antihypothyroid, an anti-infective, an anti-inflammatory (for example, gastrointestinal, nonsteroidal, steroidal), an antileprotic, an antileukemic, an antilipemic, an antilipidemic, an antimalarial, an antimanic, an antimetabolite, an antimethemoglobinemic, an antimigraine, an antimycotic, an antinauseant, an antineoplastic (for example, hormonal, photosensitizer, radiation source), an antineoplastic adjunct, an antineutropenic, an anti-obesity, an antiosteoporotic, an antipagetic, an antiparkinsonian, an antiperistaltic, an antipheochromocytoma, an antipneumocysti, an antiprostatic hypertrophy, an antiprotozoal (for example, ameda, giardia, histomonas, leishmania, malaria, pneumocystis, taxoplasma, trichomonas, trypanosoma), an antipruritic, an antipsoriatic, an antipsychotic, an antipyretic, an antirheumatic, an antirickettsial, an antiseborrheic, an antiseptic, an antispasmodic, an antisyphilitic, an antithrombocythemic, an antithrombotic, an antitubercular, an antitumor, an antitussive, an antiulcerative, an antiurolithic, an antivenin, an antivertigo, an antiviral, an anxiolytic, an appetite stimulant, an astringent, a bacterial vaccine, a bioflavonoid aromatase inhibitor, a benzodiazepene antagonist, a beta-blocker, a bone resorption inhibitor, a bradycardic agent, a bradykinin antagonist, a broncholodialator, a calcium channel blocker, a calcium regulator, a calcium supplement, a cancer chemotherapy, a capillary protectant, a capillary stabilizing agent, a coagulant, a corticosteroid, a carbonic anhydrase inhibitor, a cardiac depressant, a cardiotonic, a cathartic, a CCK antagonist, a central stimulant, a ceregral vasodilator, a chelating agent, a cholecystokinin antagonist, a cholelitholytic agent, a choleretic, a cholineric, a cholinesterase inhibitor, a cholinesterase reactivator, a central nervous stimulant, a cognition activator, a contraceptive (for example, injectable, oral), a control of intraocular pressure agent, a converting enzyme inhibitor, a coronary vasodilator, a cycloxygenase-2 inhibitor, a cytroprotectant, a debriding agent, a decongestant, a depigmentor, a detoxifying agent for cytostatic treatment, a drug for treatment of chronic alcoholism, a dermatitis herpetiformis suppressant, a diagnostic aid (for example, contrast agent, radioactive imaging agent, rediopaque medium, ultrasound contrast agent), a digestive aid, a disinfectant, a diuretic, a dopamine receptor agonist, a dopamine receptor antagonist, an ectoparasiticide, an electrolyte, an electrolyte replenisher, an emetic, an enkephalinase inhibitor, an enzyme, an enzyme cofactor, an enzyme inducer, an estrogen, an estrogen antagonist, an expectorant, an enzyme inhibitor, a ferment, a ferment inhibitor, a fibrinogen receptor antagonist, a ganglioside, a ganglioside derivative, a gastric and pancreatic secretion stimulant, a gastric proton pump inhibitor, a gastric secretion inhibitor, a gastroprokinetic, a glucocorticoid, an alpha-glucosidase inhibitor, a gonad-stimulating principle, a gout suppressant, a growth hormone inhibitor, a growth hormone releasing factor, a growth stimulant, a hematinic, a hematopoietic, a hemolytic, a hemostatic, a heparin antagonist, a heptoprotectant, a histamine H₁-receptor antagonist, a HIV proteinase inhibitor, a HMG CoA reductase inhibitor, a hormone, a hormone antagonist, a hypnotic, a hypocholesteremic, a hypolipidemic, a hypotensive, an immunomodulator, an immunosuppressant, an immunomodulator, an immunostimulant, an inotropic agent, an interceptive, an insulin sensitizer, a keratolytic, a lactation stimulating hormone, a laxative, a leukotriene antagonist, a LH-RH agonist, a lipotropic, a 5-lipoxygenase inhibitor, a local anesthetic, a lupus erythematosus suppressant, a major tranquilizer, a matrix metalloproteinase inhibitor, a mineral, a minerallocorticoid, a minor tranquilizer, a miotic, a monoamine oxidase inhibitor, a mucolytic, a muscle relaxant (for example, skeletal, smooth), a mydriatic, a narcotic analgesic, a narcotic antagonist, a nasal decongestant, a neuroleptic, a neuromuscular blocking agent, a neuroprotective, a neuromodulator, a neurotransmitter, a nootropic, an oligonucleotide, and oligonucleotide derivative, an osmotic diuretic, a parasympatholytic, a peptide, a protein, a psychostimulant, a non-steroidal anti-inflammatory drug, an opioid analgesic, an oral contraceptive, an ovarian hormone, an oxytocic, a parasympathomimetic pediculicide, a pepsin inhibitor, a peripheral vasodilator, a peristaltic stimulant, a pigmentation agent, a plasma volume expander, a potassium channel activator/opener, a pressor agent, a progestogen, a prolactin inhibitor, a prostaglandin, a prostaglandin analog, a protease inhibitor, a proton pump inhibitor, a pulmonary surfactant, a 5alpha-reductase inhibitor, a replenisher, a supplement, a respiratory stimulant, a retroviral protease inhibitor, a reverse transcriptase inhibitor, a scabicide, a sclerosing agent, a sedative, a serenic, a serotonin noradrenaline reuptake inhibitor, a serotonin receptor agonist, a serotonin receptor antagonist, a serotonin uptake inhibitor, a serum lipid reducing agent, a smooth muscle relaxant, a sympatholytic, a skeletal muscle relaxant, a somatostatin analog, a spasmolytic, a stool softener, a succinylcholine synergist, a sympathomimetic, a thrombolytic, a thromboxane A₂-receptor antagonist, a thromboxane A₂-receptor inhibitor, a thyroid hormone, a thyroid inhibitor, a thyrotropic hormone, a tocolytic, a topical protectant, a topoisomerase I inhibitor, a topoisomerase II inhibitor, a tranquilizer, an ultraviolet screen, an uricouric, a vaccine, a vector for gene therapy, a vasodilator (for example, cerebral, coronary, peripheral), a vasopressor, a vasoprotectant, a vitamin, a vitamin source, a viral vaccine, a virus, a vulnerary, a Wilson's disease treatment, and/or a xanthine oxidase inhibitor, and combinations thereof, and any therapeutic agent capable of affecting a biological system. Exemplary pharmacological agents include those described in, for example, Goodman and Gilman, the Pharmacological Basis of Therapeutics (9th Edition), McGraw-Hill, 1995; and the Merck Index, Thirteenth Edition, John Wiley & Sons, 13th edition (October 2001).

In one embodiment of the present invention, after a participant takes an initial screening and earns an incentive, future screenings (and incentives, for example) can be tied to, for example, an improved behavior, an improved health score, an improvement in an individual parameter (for example, improvement in blood pressure, weight loss or gain, blood cholesterol level or ratio, blood triglyceride level, and/or a hemoglobin A1c test), and/or adherence to a medical treatment, a behavioral modification, and/or a dietary change. The apparatuses, systems, programs, and/or methods in one embodiment of the present invention use evidence based research data that has been prepared to project potential health savings from improved health scores. Participants receive a personal report explaining and/or scoring, ranking, and/or grading their biomarkers and self-reported data. Sponsors of the assessment receive health reports that are generated from the respective aggregated user's data. These reports include, for example, general health, lifestyle, mental health, disease management and health risk economic impact information, and can be used, for example, to improve health plan designs, predictive modeling, and/or preventive strategies.

In another aspect of the present invention, a group's aggregated data can be given to a sponsor's provider and/or health consultants for the purpose of improving the deployment of programs and services that will effectively result in improving a participant's health status. Improved health lowers excessive health claims. With the consent of individual participants, their data can be shared with manufactures and research companies for the purpose of distributing additional information or materials that can help improve health scores or status. Additionally, with the consent from individuals, this data can be used in conjunction with companies performing clinical trials of various diseases and conditions, and can be used, for example, to combat lifestyle-related chronic illnesses.

In another aspect, the present invention is directed to an apparatus, system, program, and/or method for health screening and/or scoring, ranking, and/or grading. The apparatus, system, program, and/or method comprises health risk assessment and/or clinical analysis that a health care insurance sponsor (such as, for example, an employer) can provide to their participants (such as, for example, an employee) that can be used to manage and/or improve the overall health of their participants while lowering the health care insurance sponsor's healthcare claims. These incentives in one embodiment of the present invention can be used to motivate participation in the program by passing some or all of the incentives on to those participants that take part in the health screening and/or scoring, ranking, and/or grading program.

Health risk screening can include a number of instruments known to those skilled in the art to address one or more parameters used to calculate a Health Score, including, for example, a self assessment survey, which parameters may include, for example, a participants exercise habits, motor skills, alcohol use, nutrition, self care, tobacco use, and/or safety habits; a medical history survey, which parameters may include, for example, a participant's family and personal medical history, prior healthcare utilization, symptoms of disease, blood pressure, height, and/or weight (biometric data); health status survey, which parameters may include, for example, health distress, health perception, musculo-skelatal condition, mental health, pain, social functioning, stress, anxiety, vitality, biometric data, body composition, and/or body fat; and/or blood chemistry analysis, which parameters may include, for example, organ functioning and/or possible onset of disease. Blood chemistry analyses (biomedical data) in one embodiment of the present invention, include at least one of measuring or determining low density lipoprotein concentration; very low density lipoprotein concentration; high density lipoprotein concentration; ratio of low density lipoprotein and high density lipoprotein; ratio of total cholesterol to high density lipoprotein; glucose concentration (for example, hemoglobin A1c (Hb A1c) test); presence of nicotine; triglyceride concentration; gamma glutamyltransferase (GGT) liver enzyme functioning to screen for heavy alcohol consumption or other liver abnormality; albumin concentration to measure protein in blood, which tends to decrease with debilitating disease or severe malnutrition; bilirubin, which is a product of normal red cell breakdown and is another measure of liver function; blood urea nitrogen (BUN) concentration, which in a high animal fat diet is elevated; calcium concentration, which is a good measure of diet, and with a high protein diet, for example, leading to a low or negative level of calcium that can lead to osteoporosis; creatinine concentrations to asses for kidney damage; globulin concentration to assess the immune system, with variations outside normal levels being attributed to plasma cell dysfunction; blood (serum) glutamic-oxaloacetic transaminase (SGOT) enzyme (also known as aspartate aminotranskinase, aspartate transaminase, and AST) concentration, which is released into the blood when cells that contain it, for example, the liver, muscles (including the heart) and red blood cells, are damaged; blood (serum) glutamate pyruvate transaminase (SGPT) enzyme (also known as alanine transaminase, or ALT) concentration, which is released into the blood when cells that contain it, for example, the liver, are damaged; lactic acid dehydrogenase (LDH) concentration, which is an intracellular enzyme found in the kidney, heart, skeletal muscle, brain, liver, and lungs, with decreased levels of the enzyme seen in cases of malnutrition, hypoglycemia, adrenal exhaustion or low tissue or organ activity; alkaline phosphatase; total protein concentration; albumin/globulin ratio; uric acid concentration, which is a waste product of kidney breakdown, with high protein diets causing large amounts to collect in the joints resulting in inflammation or gouty arthritis or heart disease; mineral concentration, including, for example, iron, calcium, sodium, potassium, and chloride concentration; and/or Cotinine concentration. Other blood tests can also be performed including, for example, the 20 chemical panel, lipid profile, blood type, hemoglobin, prostate-specific antigen (PSA), and/or complete blood count (CBC) test.

Apparatuses, systems, programs, and/or methods in another aspect of the present invention provide a health care insurance sponsor the ability to offer incentives to their participants based on improved changes in health-risk behaviors, thereby, lowering health care claims. For example, a participant is provided with a health evaluation on a periodic basis, such as, for example, on an hourly, daily, weekly, monthly, and/or yearly basis depending on the health condition and/or health risks identified in the participant. The program collection includes, for example, at least one of a self-health assessment, a medial history, a health status survey, a biometric measurement, and/or biosample chemistry analysis. One or more of the parameters of the tests are evaluated, analyzed, calculated, scored, ranked and/or graded to produce a report and/or a health score. The report can provide the participant an explanation of, for example, their health-risk behaviors, biometric data, biomedical data (including, for example, blood, tissue, organ, saliva, hair, skin, fingernail, toenail, urine, and/or stool chemistries) and/or risk factors, including for example, modifiable risk factors. Suggestive remediations, for example, a pharmacological agent, a behavioral change, and/or dietary change, are in one aspect of the present invention, also provided to the participant. The health score can inform the participant how they fair compared to national health norms and/or current medical guidelines. Together, this information is educational and can prompt action (for example, life-style behavioral) on behalf of the participant, including, for example, changing diet, cessation of smoking and/or drug usage and/or abuse, eliminating or lowering the intake of alcohol, implementing an exercise regime, obtaining additional screening and/or treatment for identified disease risks such as cancer, diabetes, and/or cardiovascular disease, and/or being placed on medication to treat and/or reduce the risk of developing a disease or a symptom associated with a disease, which can result in improved health of the participant and lowering average health claims. In one embodiment, it is contemplated that participants will be willing to participate in such health evaluation assessments voluntarily because the selected program screens for risk factors the participants can control, treat, and/or improve. Furthermore, in yet another embodiment of the present invention, a participant can earn incentives such as favorable contribution rates, lower deductibles, and/or credits to health spending accounts linked to their health plan for participating in the health evaluation and/or improving one's health score. In still another embodiment, after a period of time after a participant has been screened and evaluated, a health care insurance sponsor ties an incentive to the achievement of a particular health score and/or the improvement of the health score by the participant. Conversely, in another embodiment of the present invention, participants that do not voluntarily participate in the program can, for example, be disqualified from preferred health plans and/or incentives and thereby may pay a higher portion of the health care insurance sponsor's expenses, pay higher fees for non-participation, and/or pay higher deductibles as compared to those who participate in the program.

Incentives can also be offered to a participant to implement a dietary change, which includes, for example, increasing (or decreasing, depending on the health condition of the participant. For example, a participant susceptible to kidney failure can be provided with incentives to increase intake of cranberries and/or decrease intake of calcium rich foods such as oranges and bananas) intake of a variety of fruits, vegetables, grains, low-fat dairy products, non-fat dairy products, fish, legumes, and sources of low saturated fat protein (for example, plant sources, poultry, lean meats), omega 3 fatty-acid supplementation, folic acid supplementation, niacin supplementation, antioxidant vitamin supplementation, limiting saturated fat intake (for example, less than about 10% of calories consumed), limiting cholesterol intake (for example, less than under about 300 mg per day), and limiting intake of trans fatty acids.

Incentives may also be provided to a participant to encourage weight gain, maintenance and/or reduction through one or more of increasing physical activity levels, adjusting caloric intake, administration of a pharmacological agent, and/or altering diet. To encourage this, for example, incentives can be provided to an adult participant to maintain or achieve a body-mass-index of between about 18 kg/m² and about 25 kg/m²; a body-mass-index of less than between about 25 kg/m² to about 29.9 kg/m² (generally considered the range for overweight adults); a body-mass-index of less than about 30 kg/m² (generally considered the point of clinical obesity); a body-mass-index of less than between 30 kg/m² to about 34.9 kg/m²; a body-mass-index of less than between about 35 kg/m² to about 39.9 kg/m²; and/or a body-mass-index of less than about 40 kg/m². Incentives can also be provided to participants for decreasing and/or increasing their body-mass-index from, for example, test to test or over a period of time. Body-mass-index can be calculated in one embodiment by either as weight in pounds divided by height in inches squared multiplied by 703, or as weight in kilograms divided by height in meters squared.

In one aspect of the present invention, the Health Score is used to quantify the health status of a participant by measuring one or more modifiable behaviors and/or risk factors. Biomedical and biometric markers and/or data are collected, for example, to assess and/or measure modifiable risk factors that impact health care claims. Such data can be ranked using a stage risk scoring, ranking, and/or grading system. For example, a five stage risk scoring, ranking, and/or grading system can inlude rankings, such as, for example, minimal risk, moderate risk, medium risk, high risk and extreme risk ranking, or the equivalent thereof. These rankings can also, for example, be reported along with the actual test results. Illustratively, a test report can state that a participant's triglycerides are 184, and that this is generally considered to be a moderate risk. Advice such that the participant should review the results and consult with his or her primary care physician can also be provided. In another aspect of the present invention, the biomarker data can be translated into a system such that the risk can be evaluated, for example, numerically, graphically, and/or alphbetically. For example, a numercial point system can be based on a 0.1, 1, 10, 100, or 1000 point graded health score, with a greater numerical value indicating better health. In an example of an alphebetical system, the scores can range from A through F, with an A indicating an excellent health score, and a F indicating a failing or low health score. Gradations from A to F indicate various degrees of a health risk.

In yet another embodiment of the present invention, Health Scores are established as a baseline from which future screenings measure changes in health status. The Health Score reports relevant content for each biomarker in a remedial fashion for easy understanding. Relevant recommendations and possible behavioral remediations can be provided for each biomarker to improve health risk status. The baseline also incorporates one of more self-reported demographics, socioeconimic and health related data, including, for example, familiar health history, personal health status, use of health care access and satisfaction, homeopathic practices, lifestyle behaviors (alcohol, tobacco, eating, and exercise habits), disease symptoms, self-health practices, work and family matters, and health planning intentions. The biomarkers (for example, clinical results) can be presented in a clear and/or organized manner that, for example, participants, health care providers, and/or doctors, can manage and/or monitor between screenings to mitigate excessive health claims. In such a case, for example, participants can be empowered with knowledge about their health that may or may not have been known to them.

Self-reported data can be used in one embodiment of the present invention, to understand what disease and/or condition a participant has and/or is susceptible to and/or prone to, and, for example, if the participant is managing it successfully. Self-reported information can also be mapped to claims and pharmacy utilization data to measure the current effectiveness of the participant's self-health practices. It is contemplated that improving a participant's self-health skills can reduce absenteeism. Furthermore, linking modifiable illness data such as, for example, asthma, hypertension, depression, and/or migraine headaches to primary care remediations can also improve the productivity of a participant. In one embodiment, scores can be calculated, reported, and/or explained within the context that a majority of the participants will comprehend from a cursory review of their personal health report. Additional homeopathic treatments, warning signs and/or action steps can be provided to the participants by a self-health handbook, a self-care handbook, a web page or website, a pamphlet, and/or a book, for example.

In yet another aspect of the present invention, aggregated data can include general health summaries, mental health summaries, lifestyle summaries, disease management, and/or health risk economic forecasts. Such data can be used in one embodiment, to optimize Employee Assistance Programs, disease management contracts, and/or case manager contracts by, for example, “pushing” at-risk and/or no claim participant data to providers. The goal of such “pushing” is to increase the frequency of low risk claims through early detection and treatment, while reducing the aggregate cost caused by excessive and catastrophic claims. This objective can provide a turnkey benefit that encourages participant accountability to improve and sustain good health practices with compounding existing resources. Improvements in predictive modeling and claims forecasting by having hard data on “at-risk” populations can also be achieved.

In another aspect of the present invention, the biosample (for example, blood, tissue, organ, saliva, hair, skin, fingernail, toenail, urine, stool sample) and/or biometric data are scored against nationally published data.

In still another aspect of the present invention, participants are identified for incentives based upon having metabolic syndrome, which term is used herein to refer to a cluster of health problems associated with cardiovascular disease. In one embodiment, the factors of the metabolic syndrome are use to predict heart attack risk in a participant. Illustratively, participants in one embodiment of the present invention, are considered to have metabolic syndrome when two or more of the following are identified in the participant: (1) obesity around the waist, (2) high blood pressure (optimal blood pressure generally considered to be less than about 120/80 Hg, with pharmacotherapy indicated when blood pressure is greater than 140/90 Hg in normal adults with lower blood pressure in settings of blood pressure-related target-organ damage or diabetes), (3) low serum levels of good cholesterol, (4) difficulty metabolizing blood sugar (for example, the presence of clinical type 2 diabetes (fasting plasma glucose of greater than or equal to about 126 mg/dL or about 2 hours postprandial plasma glucose of greater than or equal to about 200 mg/dL) is a major risk factor for cardiovascular disease, and it alone can indicate an elevated risk of heart attack), and (5) high levels of serum triglycerides. See, for example, Mosca L., et al., Evidence-Based Guidelines for Cardiovascular Disease Prevention in Women, Circulation, February 2004; 109: 672-693.

In yet another aspect of the present invention, incentives to modify or alter behavior (for example, implementing a heart-healthy diet or exercise regime) and/or implement pharmacotherapy are based upon having one or more risk factors for heart attack and may be further incentivized by the level of risk a particular risk factor is associated with in having a heart attack. Such risk factors include, for example, factors indicating high risk, such as, for example, established coronary heart disease, cerebrovascular disease, peripheral arterial disease, abdominal aortic aneurysm, diabetes mellitus, and/or chronic kidney disease; factors indicating intermediate risk, such as, for example, subclinical cardiovascular disease (for example, coronary calcification), metabolic syndrome, multiple risk factors as determined by the Framingham Coronary Heart Disease Risk Scoring System, markedly elevated levels of a single risk factor as determined by the Framingham Coronary Heart Disease Risk Scoring System, first-degree relative(s) with early-onset (in men aged 55 or older, in women aged 65 or older) atherosclerotic cardiovascular disease; factors indicating lower risk, such as, for example, one or no risk factors as determined by the Framingham Coronary Heart Disease Risk Scoring System; and factors indicating optimal risk, such as, optimal levels of risk factors as determined by the Framingham Coronary Heart Disease Risk Scoring System and/or heart-healthy lifestyle. See, for example, Mosca L., et al., Evidence-Based Guidelines for Cardiovascular Disease Prevention in Women, Circulation, February 2004; 109: 672-693. Additionally, information to determine coronary heart disease and stroke risk is available at http://www.nhlbi.nih.gov/about/framingham/, which includes a description of the Framingham Coronary Heart Disease Risk Scoring System and the Framingham Stroke Risk Scoring System. Current methods for detecting a subject's susceptibility to stroke are well known, including, for example, positron emission tomography (PET) and sonogram technology to image capillaries in the brain. A stroke can also be preceded by changes in blood flow in the brain, and may occur well in advance of the stroke, sometimes appearing months beforehand. Blood flow may be diminished in a blood vessel, for example, as a result of plaque build-up in the vessel. Moreover, this can lead to the generation of capillaries to compensate for the decreased blood flow in the original blood vessel. Plaque build-up may continue to the point of complete blockage, leading to a stroke. Alternatively, a sudden dislodging of the plaque can bring a sudden increase in blood flow to the newly developed capillaries, which can also lead to a stroke. Other methods of detecting and/or assessing for the risk of stroke can also be found in U.S. Pat. Nos. 6,251,587; 6,280,393; and 6,466,816.

In yet another aspect of the present invention, incentives to modify and/or alter behavior (for example, implementing a heart-healthy diet or exercise regime) and/or implement pharmacotherapy are based upon the age of the participant (for example, a male reaching the age of 45 in relations to susceptibility to diabetes), and/or the participant reaching a certain stage in life (for example, a women reaching menopause). In women, for example, osteoporosis is a life long disease process but most often becomes clinically evident in post-menopausal women. The cause of osteoporosis can be traced to changes in the bone remodeling process that result from decreased estrogen, decreased mechanical loading on the bone, and a variety of other factors that combine to reduce the density of the bone and increase the likelihood of bone fractures. Treatments of the condition include estrogen replacement or bisphosphonate therapy. Bone is a living structure that undergoes constant remodeling throughout the life of an individual. The principle cells involved in bone remodeling are osteoblasts, which build bone, and osteoclasts, which break it down. The action of these two cells is tightly coupled in a normal individual to maintain healthy bone, including optimal remodeling rates and bone mineral density levels. Any uncoupling of the action of these two cell types can cause suboptimal bone mineral density and weaken the bone, making fracture more likely. Estrogen is related to osteoclast activity, such that decreases in estrogen increase bone breakdown rates, leading to weakened bone. Estrogen supplements reestablish more optimal bone remodeling patterns and incentives to begin estrogen therapy can be implemented at menopause to treat and/or prevent osteoporosis.

It is estimated that over 4500 identified human diseases are due to genetic defects in the human genome. It is generally believed that a single defect or multiple defects in a given gene cause the resulting disease or diseases. It is contemplated that many of these diseases can be alleviated, at least in part, if the deficient function can be supplied. Incentives to test for such defects can be provided to a participant in one embodiment of the present invention. Additional incentives can also be provided once a defect has been identified in the participant, for the participant to administer a pharmacological agent to correct and/or alleviate the deficient function of the gene defect, implement gene therapy to correct and/or alleviate the deficient function of the gene defect, implement a behavioral, exercise, and/or dietary change to prevent and/or treat the deficient function and/or lower the risk of developing a disease and/or disorder associated with the deficient function.

In another aspect of the present invention, incentives are provided to a participant to have performed a diagnosis of a disease and/or condition. Many diagnostic techniques are well known in the art, and in one embodiment, the diagnosis is by detecting genetic abnormalities and/or defects from a sample of the participant, including, for example, a DNA and/or protein sample, and/or to have performed a test that detects a genetic marker from a sample of the participant, including, for example, a DNA and/or protein sample that predicts and/or indicates a risk of developing a disease and/or condition. Such DNA and protein samples can include, for example, a tissue sample, blood, an organ, saliva, hair, bodily fluids, and/or an affected body part of the participant. It is also possible to amplify target DNA by using gene amplification means, such as, for example, PCR, if the amount of the available sample is limited. In one embodiment, the samples of tissue, blood, organ, saliva, hair, bodily fluids, and/or affected parts collected from the participant are forwarded to a test center for diagnosis. In yet another embodiment of the present invention, a genetic diagnosis or analysis apparatus and/or a genetic diagnosis support system is provided at the location at which the participant has submitted the DNA and/or protein sample, including, for example, the workplace, a hospital, a medical institution, a university, a doctor's office, and/or an exercise facility. Such genetic diagnosis or analysis apparatuses can include, for example, a DNA detector for detecting gene expression, gene representation, and/or the single nucleotide polymorphisms (SNPs) of genes from samples of, for example, tissue, blood, bodily fluids, or affected parts collected from the participant. Other processes, such as, for example, attaching a fluorescent marker element to target DNA or performing DNA amplification using a PCR method, can also carried out by the DNA detector unit. The DNA detector can also hybridize probe DNA with target DNA using DNA chips, in order to facilitate the detection of DNA. A reader that reads, for example, by means of fluorescence, the expression, gene representation, and/or the sequence of the target DNA that combines with the probe DNA can also be incorporated into the present invention. Furthermore, an analyzer that refers to a diagnosis protocol database can in one embodiment analyze the results of the DNA detector. The analyzed results may be outputted to provide information regarding the type, progress, stage and prognoses of a disease, drug sensitivities and resistance, metabolic capability and/or other items. The diagnosis protocol database may contain such information as, for example, the type of disease indicated by that detected by the DNA detector, the progress, stages and prognoses of diseases, or the diathesis, drug sensitivity, drug resistance, and/or metabolic capability of the participant in question. In another embodiment of the present invention, the diagnosis protocol database can be stored in a local area network (LAN), a network-connected content server, and/or incorporated into the analyzer itself The diagnosis protocol database can also in one embodiment, contain, for example, correlation data that correlates expression profiles of chromosomes, DNA, RNA and/or protein with a disease (for example, infectious diseases, cancer, or lifestyle-related diseases) and/or condition; correlation data correlating amounts of chromosomes, DNA, RNA and/or protein expression with the progress, stages and/or prognoses of a disease; and/or correlation data correlating expression profiles of SNPs with diathesis, drug sensitivity, drug resistance and/or metabolic capability of the participant. Such correlation data can also be combined as necessary with their respective diagnostic information.

In one aspect of the present invention, a physician and/or technician trained in the relevant art provides a diagnosis according to the information obtained from a test and/or analysis, and may conclude, for example, the type of disease present, a treatment plan (including, for example, surgery or administration of a pharmacological agent), and/or preventive actions. See, for example, U.S Published Patent Application Nos. 04/0009523 and 03/0175782, for examples of DNA diagnosis and analysis techniques useful in the present invention.

In yet another embodiment, as a participant's genes are examined the type of pharmacological agent and/or treatment method are determined that is agreeable to the diathesis of the participant, thus potentially eliminating the side effects of the medicine and/or treatment method.

In the area of cancer, currently there are only a handful of treatments available for specific types of cancer, and these provide no guarantee of success. In order to be most effective, these treatments require not only an early detection of the malignancy, but also a reliable assessment of the severity of the malignancy. The incidence of breast cancer, for example, a leading cause of death in women, has been gradually increasing in the United States over the last thirty years. While mechanism of tumorigenesis for most breast carcinomas is largely unknown, there are genetic factors that can predispose some women to developing breast cancer. BRCA1 and BRCA2 are generally believed to be genetic factors that can contribute to familial breast cancer. (See for example, U.S. Patent Application No. 2003/0224374). Germ-line mutations within these two loci are associated with a 50 to 85% lifetime risk of breast and/or ovarian cancer. However, only about 5% to 10% of breast cancers are associated with breast cancer susceptibility genes, BRCA1 and BRCA2. The cumulative lifetime risk of breast cancer for women who carry the mutant BRCA1 is predicted to be approximately 92%, while the cumulative lifetime risk for the non-carrier majority is estimated to be approximately 10%. BRCA1 is a tumor suppressor gene that is involved in DNA repair and cell cycle control, which are both important for the maintenance of genomic stability. More than 90% of all mutations reported so far result in a premature truncation of the protein product with abnormal or abolished function. The histology of breast cancer in BRCA1 mutation carriers differs from that in sporadic cases, but mutation analysis is the only way to find the carrier. Like BRCA1, BRCA2 is involved in the development of breast cancer, and like BRCA1 plays a role in DNA repair. However, unlike BRCA1, it is not involved in ovarian cancer. Other genes have been linked to breast cancer, for example c-erb-2 (HER2) and p53. Overexpression of c-erb-2 (HER2) and p53 have been correlated with poor prognosis, as has been aberrant expression products of mdm2 and cyclinl and p27. Sporadic tumors, those not currently associated with a known germline mutation, constitute the majority of breast cancers. It is also likely that other, non-genetic factors also have a significant effect on the etiology of the disease. Regardless of the cancer's origin, breast cancer morbidity and mortality increases significantly if it is not detected early in its progression. Thus, incentives can be implemented, for example, to provide for early detection of cellular transformation and tumor formation in tissue. Typically, the diagnosis of breast cancer requires histopathological proof of the presence of the tumor. In addition to diagnosis, histopathological examinations also provide information about prognosis and selection of treatment regimens. Prognosis may also be established based upon clinical parameters such as tumor size, tumor grade, the age of the patient, and lymph node metastasis. Diagnosis and/or prognosis may be determined to varying degrees of effectiveness by direct examination of the outside of the breast, or through mammography or other X-ray imaging methods. However, the National Cancer Institute has not recommended mammograms for women under fifty years of age, since this group is not as likely to develop breast cancers as are older women. In clinical practice, accurate diagnosis of various subtypes of breast cancer is important because treatment options, prognosis, and the likelihood of therapeutic response all vary broadly depending on the diagnosis. Accurate prognosis, or determination of distant metastasis-free survival could allow the oncologist to tailor the administration of adjuvant chemotherapy, with women having poorer prognoses being given the most aggressive treatment. Furthermore, accurate prediction of poor prognosis would greatly impact clinical trials for new breast cancer therapies, because potential study patients could then be stratified according to prognosis. It is contemplated that other types of cancers can also be detected and diagnosed by genetic factors (and treated by gene therapy, for example), including, for example, carcinomas, sarcomas, malignant glioma, melanoma, hemangioma, leukemia, lymphoma, myeloma, colorectal cancer, non-small cell carcinoma, breast cancer and/or ovarian cancer, and other cancers described herein.

In yet another embodiment of the present invention, gene expression profiling using DNA microarray and hierarchical clustering analysis are used to diagnosis and/or classify diseases and/or disorders, including, for example, subgroups of multiple myeloma, and/or identify genes with differential expression in subsets of subjects, and/or identify potential therapeutic targets for the disease and/or disorder. (See, for example, U.S. Published Patent Application No. 04/0009523). Such information can be used in one embodiment of the present invention as the basis for incentives and/or calculating incentives.

Methods of gene therapy are known to those skilled in the art, and cell-based gene transfer is a known, albeit relatively new and experimental, technique for conducting gene therapy on an individual. In this procedure, DNA sequences containing the genes which it is desired to introduce into the individual's body (the trans-gene) are prepared extracellularly, for example, by using enzymatic cleavage and subsequent recombination of DNA from the individual's cells with insert DNA sequences. Mammalian cells such as the individual's own cells are then cultured in vitro and treated so as to take up the transgene in an expressible form. The trans-genes may also in another embodiment of the present invention be foreign to the mammalian cell, or additional copies of genes already present in the cell, to increase the amount of expression product of the gene. Then the cells containing the trans-gene are introduced into the individual, so that the gene may express the required gene products in the body, for therapeutic purposes. The take-up of the foreign gene by the cells in culture may be accomplished by genetic engineering techniques, for example, by causing transfection of the cells with a virus containing the DNA of the gene to be transferred, by cell fusion with cells containing the required gene, by lipofection, by electroporation, or by other accepted means to obtain transfected cells. This is sometimes followed by selective culturing of the cells that have successfully taken up the transgene in an expressible form, so that administration of the cells to the individual can be limited to the transfected cells expressing the trans-gene. In other cases, all of the cells subjected to the take-up process are administered. This procedure generally involves the administration of the cells containing the trans-gene directly to the body organ requiring treatment with the expression product of the trans-gene. For example, transfected cells in an appropriate medium can be directly injected into the liver or into the muscle requiring the treatment, to enter the systemic circulation of the organ requiring treatment. Introducing genetically modified cells into the systemic circulation are also known. (See, for example, U.S. Pat. No. 6,592,864). U.S. Pat. No. 6,645,942, for example, describes a gene therapy method based on the use of transduced fibroblasts that are implanted in the loose connective tissue of the skin of the subject to be treated. U.S. Pat. No. 6,696,423 describes methods and pharmaceutical compositions for treating cancer by in vivo interferon-beta gene therapy. The method includes, for example, modifying cells of a mammalian recipient with DNA encoding a secreted protein such as human interferon in situ. U.S. Pat. Nos. 6,695,830 and 6,398,757 describe a gene therapy method for delivering a medication into an arterial wall of an individual for prevention of restenosis.

In yet another aspect of the present invention, Health Score weighting can vary from sponsor to sponsor and be flexible per sponsor and the perceived and/or identified factors that most greatly influence the health of the participants. For example, for a company whereby very few employees smoke, the weighting can be increased based on other risk factors other than smoking, such as, for example, body fat or serum cholesterol levels, as compared to a company whereby a large percentage of employees smoke. Also, such data can be combined with self-reported data to further elucidate the health condition of a participant. For example, if a 24-year-old male has no other risk factors other than smoking, smoking is not likely to impact his health claims for years. But if he smokes and self-reports that he has asthma, he now falls into a dangerous condition, and would consequently increase the risk of illness significantly. In yet another example, the present invention is flexible and based upon the population's general character and/or a sponsor's selection. For example, a self-insured trucking company may know that 25% of catastrophic claims are linked to accidents whereby drivers do not wear seat belts. In such a case, the program can score for seat belt usage and be incentivized to encourage participants to wear seat belts.

In one embodiment of the present invention, an apparatus, system, program, and/or method of altering behavior of a participant in a health care insurance plan is provided. The apparatus, system, program, and/or method comprises offering one or more incentives to the participant to complete a health risk assessment questionnaire, complete a biometric measurement analysis, and/or provide a biosample for biomedical analysis; scoring, ranking, and/or grading the health risk assessment and/or the biometric analysis for one or more health risks; analyzing the biosample for one or more biomedical parameters; scoring, ranking, and/or grading the scored health risk assessment questionnaire, the biometric parameters, and/or biomedical parameters and determining a Health Score to assess for presence or risk of disease; and optionally providing one or more incentives to the participant to achieve, maintain, or improve their Health Score over a period of time, and/or to certify they are being treated by a physician and complying with their care.

In still another embodiment of the present invention, the time interval between each Health Care assessment needed to maintain and/or qualify for an incentive or benefit is based on a particular disease and/or disorder the individual is inflicted with or is prone to, and/or its degree or severity. For example, an individual with a score indicating a high propensity for diabetes (for example, family history, obesity, elevated glucose levels compared to non-diabetic individuals) or a high risk of complications caused from diabetes (such as, for example, heart attack, amputation, loss of eyesight) may require health-status testing on an hourly, twice-a-day, three-times-a-day, four-times-a-day, daily, weekly, or monthly basis after a baseline measurement is determined to maintain a benefit, while someone with a low propensity for diabetes may only require health-status testing on a yearly basis, or longer, after a baseline measurement is determined. This frequency may also be age dependent. For example, current medical practice as recommended by the American Diabetes Association calls for individuals to be tested for diabetes after the age of 45. This is generally believed to be due to as individuals age the propensity for disease increases. Illustratively, in initially testing individuals for diabetes, a hemoglobin A1c test can be given to show blood-sugar averages over a three-month period. A normal (non-diabetic) hemoglobin A1c level is a score of about 6, while in the diabetic United States population it averages about 9, indicating minimal control. A hemoglobin A1c level below about 7 indicates optimal control of blood-sugar levels in a diabetic individual, while a level of above about 9.5 indicates a very dangerous or very high risk level. As every point-drop or fraction of a point lowers the risk of a diabetic complication, an incentive can be based upon, for example, achieving one or more point-drops, or one or more fraction-of-point-drops, to levels at or below about 7, 6.75, 6.5, 6.25, 6, 5.75, 5.5, 5.25, or 5, for example. In one embodiment, an individual aged about 45 or older with a hemoglobin A1c level of about 6 would require testing every year or so to maintain a benefit, while this individual with an hemoglobin A1c level of about 7 would require testing more frequently, such as, for example, every three months to maintain a benefit. Individuals with higher hemoglobin A1c levels would require testing more frequently, for example, an individual with a hemoglobin A1c level of about 9 or above can be required to take daily blood glucose measurements to maintain their current benefit level. Other diseases can similarly be incentivized using testing techniques, medical testing devices (see, for example, U.S. Patent Application Publication No. 03/0050537) and/or analyses known to those skilled in the art.

In yet another embodiment of the present invention, Health Scores and/or incentives are based on medical testing devices incorporating one or more tests, such as, for example, a hemoglobin A1c test, a blood-pressure test, a lipids test, a cholesterol test, a peak-flow test, an oxygen saturation test, a spirometer test, an exercise-based test, a heart-rate test, a body-fat test, a prescription-adherence test, a medical-laboratory test, a body-weight test, a chemotherapy-based test, a temperature-based test, a kidney-dialysis test, and/or a neuropathy test. Such tests and/or devices may be incorporated into the present methods and/or systems for monitoring and/or calculating Health Scores and/or incentives, including those devices described in, for example, U.S. Patent Application Publication No. 03/0050537.

In another embodiment of the present invention, the incentive information is calculated in accordance with an incentive program or algorithm. Illustratively, the incentive program bases the incentive on the Health Score of the participant determined initially or after a period of time after the initial determination. For example, the period of time between an initial determination of a Health Score and a subsequent one can vary depending on the health condition of the participant, and, for example, can be about once, twice, three, four, five, six times a day, a day, a week, a month, two months, three months, four months, five months, six months, seven months, eight months, nine months, ten months, eleven months, twelve months, or more. Factors that influence the incentive program can be determined by sponsors (for example, an employer) and can be linked, for example, to “healthy” test results, or improvements in test results from test to test. Such test results can be based on, for example, the type of disease being incentivized, the method of treatment necessary or implemented to treat the disease or condition (for example, medicine versus exercise versus diet), and/or length of time needed to treat the disease or condition (for example, chronic disease (for example, emphysema) versus acute disease (for example, a viral or bacterial infection)).

In one embodiment of the present invention, a participant to determine the participant's health score completes a health survey. A health survey can include, for example, a health risk assessment questionnaire, a biometric measurement analysis, and/or a biomedical analysis of, for example, a biosample. Such health surveys can include one or more questions such as, for example, the participant's age, gender, height, weight, inches around the wrist between the wrist bone and hand, inches around the waist at belly button in indoor clothes, inches around the neck, body frame, body fat calculation, blood pressure, and/or serum triglyceride and glucose concentrations; the participant's education and/or job function; the participant's health related behaviors such as family history of cancer, diabetes, heart problems, high blood pressure, high cholesterol, or stroke; whether the participant has a health condition such as allergies, angina, asthma, back pain, cancer, chronic bronchitis/emphysema, depression, diabetes, heart disease, high cholesterol, hypertension, kidney disease, liver disease, migraines, osteoporosis, past stroke, or thyroid; whether medication is being taken to treat a health condition; how many times in the past 12 months has the participant had a routine physical, gone to the emergency room, stayed overnight in a hospital, used a 1-800 number for medical advice, used a self-care book, or been treated with alternative medicine (for example, acupuncture, chiropractic care); whether the participant is pregnant and if so, in which trimester and whether she is under a doctor's care; whether a female participant is planning a pregnancy within the next 12 months; whether the participant knows what steps to take at home to treat health problems such as back pain, colds, flu, constipation, diarrhea, headaches, indigestion, rashes, sore throats, or sprains; whether the participant has ever been told by a doctor, nurse, or other health professional that he or she is obese; whether the participant uses or has used tobacco or illegal drugs (and how often and how much), and whether the participant is still using tobacco or illegal drugs; the number of alcoholic drinks the participant consumed in a week, and the maximum number in one day; whether the participant has driven or ridden in a car when the driver had perhaps too much to drink; the amount of daily calories consumed and how many calories burned through routine activities; the number of glasses of water consumed daily; how many servings of food eaten in a day that are high in fiber, cholesterol, and/or fat; how often is salt added to food, or how often is salty food or fast foods are consumed; the participant's blood pressure, total cholesterol level, high density lipoprotein cholesterol level; how often does the participant exercise per week, or participate in any strength building or stretching exercises; whether during the past 30 days the participant's mental health was not good; how many days in the past 30 days did poor physical or mental health keep the participant from doing usual activities, work, or recreation; the number of hours of sleep the participant usually gets at night; the general level of satisfaction with one's life; how often the participant feels tense, anxious, or depressed; how often does the participant use drugs or medication (including prescription drugs) which affects mood or helps the participant relax; whether the participant has suffered a personal loss or misfortune in the past year; the number of days in the past year the participant's emotional health kept he or she from working all or most of the day; the number of days in the past year an illness or injury kept the participant from working all or most of the day; how the participant would consider his or her overall physical health; to assess for diabetes whether the participant has experiences frequent urination, excessive thirst or hunger, dramatic weight loss, irritability, weakness, fatigue, nausea, vomiting, persistent indigestion, difficulty swallowing, or any sore that does not heal; to asses for heart disease whether the participant has experiences chest discomfort, shortness of breadth, numbness or weakness of the face, arm, or leg, trouble walking, dizziness, loss of balance, sudden severe headaches without known cause, breaking out in a cold sweat, nausea, or lightheadedness; to assess for cancer whether the participant has experienced unusual bleeding or discharge, change in bowel or bladder habits, nagging cough or hoarseness, persistent indigestion or difficulty swallowing, obvious change in skin such as a freckle, mole or wart, any sore that does not heal, or thickening or lump in the breast or elsewhere; when the last time the participant received a flu, pneumonia, or tetanus shot; whether a male participant has been told by a doctor, nurse or health care professional that he has or had colorectal, lung, prostate, or testicular cancer; whether a male participant has been examined for testicular lumps, or checked for prostate (using, for example, a prostate-specific antigen, finger rectal exam, or transrectal ultrasound) or colorectal (using, for example, a finger rectal exam, fecal occult blood test, or sigmiodoscopy) cancer by a physician; whether a female participant has ever been told by a doctor, nurse or health care profession that she has or had breast, cervical, colorectal, or lung cancer; how many women in a female participant's natural family (mother or sisters only) have had breast cancer; whether a female participant performs a monthly self-exam of the breast for lumps; whether a female participant over age 35 has ever had a mammogram; whether a female participant has ever had a pap smear (and length of time since the last pap smear); the age at which a female participant has first starting menstruating; whether a female participant has been checked for colorectal cancer (using, for example, a finger rectal exam, fecal occult blood test, or sigmiodoscopy) by a physician; whether the participant is satisfied with his or her job; whether the participant is creating a balance between personal, couple, family and career goals; how strong the participant's social ties are with family and/or friends; whether the participant schedules quiet, rejuvenating time each day; whether the participant schedules time, daily or weekly, separately from his or her spouse and/or each child; whether the participant leaves his or her job worries at the office and the family worries at home; what changes the participant has done in the past 12 months, or plans to do in the next 6 months, to enhance his or her health, including, for example, increase physical activity, lose weight, reduce alcohol use, quit or cut down on smoking, reduce fat and/or cholesterol intake, lower blood pressure, lower cholesterol level, or cope better with stress.

In yet another aspect of the present invention, a family history health characteristic associated with a participant is included in a health risk assessment questionnaire. Illustratively, questions addressing if there is a history of a particular health risk within the family, for example, heart failure, cancer, high blood pressure, or stress, are used to establish a family medical history through self-reported information from the participant. Alternatively, the information may be obtained from an independent source. The independent source may include a participant's medical or drug claim records (for example, via a hospital, doctor, pharmacist, or associated records), or by identifying the participant's relevant family members and directly acquiring the desired information from the identified family members medical records. In one embodiment, prior authorization from the participant and family members would be acquired to enable access to this information. In another aspect of the present invention, health related information includes information associated with a lifestyle characteristic associated with a participant. Illustratively, a lifestyle characteristic includes a specific participant's behavior characteristic or characteristics, of which some or all may be modifiable lifestyle characteristics. A modifiable lifestyle characteristic may include, for example, a lifestyle characteristic of a specific participant that provides an indication of the participant's current or future health, and which may be modifiable. For example, modifiable lifestyle characteristics may include an exercise characteristic (for example, does the participant exercise, how often, what is the exercise) and/or a nutrition characteristic (for example, what types of food does the participant eat, and how often). Nutrition characteristics may also include the amount of salt consumed during a designated period (for example, a day, week, month), and/or the amount of fat and/or saturated fat consumed during a designated period. In addition, the modifiable lifestyle characteristics may include whether the participant drinks alcohol (and if so how much), a drug intake characteristic, (for example, does the participant take drugs, and if so how often, what kind, and how much), a weight characteristic (for example, what does the participant weigh, what is the participant's desired weight, is the participant on a diet, what is the participant's weight indicator (for example, obese, slightly overweight, anorexic, normal), a smoking characteristic (does the participant smoke and if so how much), a safety characteristic (what are the participant's driving characteristics, for example, does the member where seat belts, have one or more infractions associated with driving under the influence (for example, of alcohol), or speeding tickets, or drive excessively fast). addition, the modifiable lifestyle characteristic may include a hypertension characteristic, a stress characteristic, a self-care characteristic, a self-efficacy characteristic, and a prophylactic aspirin therapy characteristic. In one embodiment, the health related information may also include one or more of the following: the location or geography, age, gender, employment status, and employment type of the participant. The lifestyle characteristic may be established through a self-assessment or an independent source.

In another embodiment of the present invention, a health survey can include one or more questions related to the health of an individual, including, for example, the state of an individual's cardiovascular system, pulmonary system, skeletal system, neurological system, muscular system, cellular system, skin system, nervous system, hormonal system, endocrine system, brain system, paracrine system, reproductive system, vision system, waste system, hearing system, olfactory system, circulatory system, immune system, regenerative system, regulatory system, digestive system, or other biological systems. Additional questions can be directed to the treatment, testing, consultation, diagnosis, therapy, transplantation, gene therapy, medication, and/or surgery related to such biological systems.

In another embodiment of the present invention, biomedical analysis of a biosample can be utilized to assess the health of an individual, including, for example, the state of an individual's cardiovascular system, pulmonary system, skeletal system, neurological system, muscular system, cellular system, skin system, nervous system, hormonal system, endocrine system, brain system, paracrine system, reproductive system, vision system, waste system, hearing system, olfactory system, circulatory system, immune system, regenerative system, regulatory system, digestive system, or other biological systems.

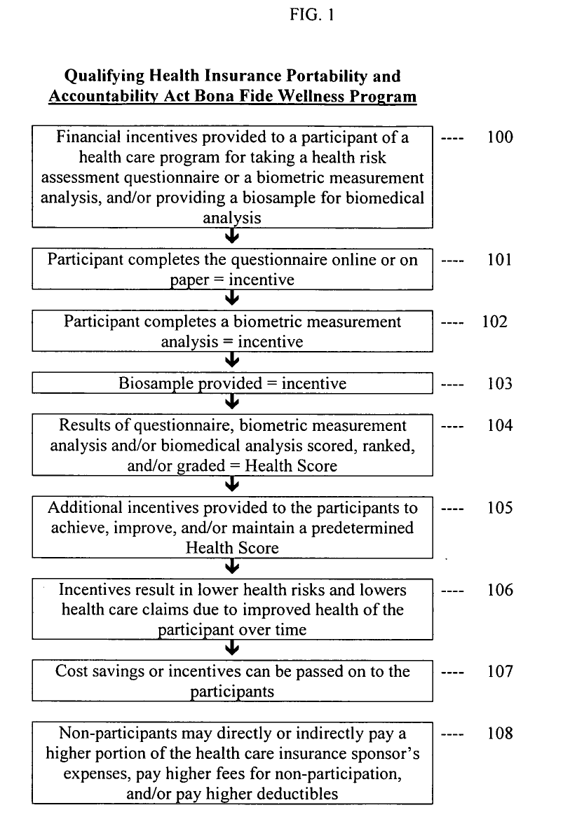

Illustratively, the apparatuses, systems, programs, and/or methods provided by the present invention can be implemented to qualify as a bona fide wellness program under the Health Insurance Portability and Accountability Act (HIPAA) of 2003 (See, for example, FIG. 1). The provisions of the Act allow employers to utilize qualified programs that promote good health to create different health plan structures based on participation and/or employee health scores. Under the Act, all Personal Health Information must remain strictly confidential, secure, and private, but health scores can be reported to employers and linked to preferred rates for good health scores. Incentives can be designed into a company's health plan that encourages employee participation in order to maximize positive health benefits to the employees thereby lowering health care claims and thus costs. Currently, under the Act, a program that makes financial incentive contingent upon the satisfaction of a standard related to a health factor satisfies four criteria to be a “bona fide” wellness program: (1) the reward, coupled with those for any other wellness programs that link rewards to a health-related standard, may not exceed a certain percentage of the cost of employee-only coverage under the plan, (2) the program must be reasonably designed to promote good health or prevent disease, and eligible participants must be given the opportunity to qualify for the reward at least once per year, (3) the reward must be available to all similarly situated individuals, which means that in cases in which a participant's medical condition makes it unreasonably difficult to achieve the standard (or cases in which it would not be medically advisable to do so), a participant must be given the chance to satisfy a “reasonable alternative standard,” (such as, for example, a letter from a physician that a participant is under their care to improve the health risk identified in the assessment), and (4) materials describing the wellness program must disclose that these alternative standards are available. It may be necessary in some situations to qualify as a “bona fide” wellness program to work with an individual participant where it is unreasonably difficult due to the medical condition to achieve the standards for the reward under the program, or it is medically inadvisable for the participant to achieve the standards for the reward under the program. The proposed rules under the Act provide the following examples of how alternative standard arrangements can be implemented: (1) A bona fide wellness plan gives premium discounts to participants who have cholesterol levels lower than 200; a participant who is unable to achieve that standard, either because a medical condition makes it unreasonably difficult to do so, or because doing so is medically inadvisable, could be offered an alternative of going on a low-cholesterol diet; (2) A bona fide wellness plan may impose a surcharge on all participants who have used tobacco products during the past 12 months; however, a participant who is unable to avoid tobacco products due to a medical condition, for example, a nicotine addiction, must be given a reasonable alternative, such as attending a smoking cessation program, to avoid the surcharge; that surcharge would have to be waived for as long as the participant continued the smoking cessation program, whether or not he or she quit smoking.

It is also contemplated that as participants receive their personal health reports or health scores, average health scores will improve and average annual healthcare claims will be reduced within a period of time of, for example, one year after implementation of the program.

In general terms, one embodiment of the present invention is described in FIG. 1, which sets out a flow diagram by which an incentive based program provides a Health Insurance Portability and Accountability Act bona fide wellness program. First, a financial incentive system 101 is implemented as part of a health care plan provided by, for example, an employer to its employees. The incentive plan is based on participating in a health risk assessment evaluation, which provides, for example, a contribution discount of a premium for participation. Illustratively, contribution discounts of a premium can be based on statutory systems such as the Health Insurance Portability and Accountability Act (for example, 20% of the premium in 2004), for example, and/or can range from, for example, about 0.1% to about 99%, or about 0.1%, or about 0.5%, or about 1%, about 2.5%, about 5%, about 7.5%, about 10%, about 12.5%, about 15%, about 17.5%, about 20%, about 22.5%, about 25%, about 27.5%, about 30%, about 32.5%, about 35%, about 37.5%, about 40%, about 42.5%, about 45%, about 47.5%, or about 50%, or about 55%, or about 60%, or about 65%, or about 70%, or about 75%, or about 80%, or about 85%, or about 90%, or about 95%, or about 99%, or more. These percentages can vary from about 1% to about 20%, or more, depending on the amount of incentive necessary to implement behavioral change in the health care insurance participants. In one aspect of the present invention, if a health risk assessment questionnaire 101 is to be completed as part of the program, before, during, or after the participant completes an online, telephonic, electronic, or paper health risk assessment questionnaire, the participant completes a biometric measurement analysis 102, and/or a biosample is taken or drawn and analyzed for health-related biomarkers (biomedical data) 103. The biometric data and/or the biosample data are then scored to assess the presence or risk of disease (a Health Score 104), and/or whether the biometric and biomedical data corresponds to the self-reported data provided by the health risk assessment questionnaire. Where the self-reported data does not correspond to the biometric and/or biomedical data, for example, self-reported data states no tobacco use while the analysis of the biosample indicates the presence of nicotine, such discrepancies can be reported to the individual reporting such data as well as those administering the tests and/or program to the individual. Additional incentives provided to the participants to achieve, improve, and/or maintain a predetermined Health Score 105. Incentives result in lower health risks and lowers health care claims due to improved health of the participant over time 106. The information received for participating in the program can result in healthier participants due to the identification of potential health risks and/or disease leading to treatment of such health risks and/or disease. Cost savings or incentives can be passed on to the participants 107. Information can also be provided to participants to alter health-risk behaviors that negatively impact the identified health risk and/or disease, or guide participants to sponsor or employer sponsored programs, such as, for example, an Employee Assistance Program (EAP). Such information can motivate participants to prevent and/or treat such health risks and/or disease by providing support and guidance on altering health-risk behaviors. Additionally, and not wishing to be bound by theory, it is believed that a healthier person can result in a better employee through improved job performance, increased life expectancy, improved productivity due to less absenteeism and/or disabilities, and/or improved retention. Non-participants may directly or indirectly pay a higher portion of the health care insurance sponsor's expenses, pay higher fees for non-participation, and/or pay higher deductibles 108.

In one embodiment of the present invention, an apparatus, method, program, and/or system of providing incentives to a participant of a health care insurance plan for achieving, maintaining or improving a Health Score is provided. The apparatus, method, program, and/or system comprises providing at least one health risk assessment questionnaire to one or more participants of the health care insurance plan; scoring, ranking, and/or grading the health risk assessment and/or the biometric analysis for one or more health risks; obtaining one or more biosamples from the participant and analyzing the biosample for one or more biomedical parameters; obtaining one or more biometric measurements; analyzing the scored health risk assessment questionnaire and/or the biometric parameters and/or the biometric parameter and determining a Health Score in connection with an incentive program; and calculating an incentive based on the Health Score and the incentive program.

In yet another embodiment of the present invention, an apparatus, method, program, and/or system of encouraging participation in an incentive based insurance program is implemented to reduce health care claims. The apparatus, method, program, and/or system comprises offering one or more incentives to one or more participants of a health care insurance plan to perform at least one of completing one or more health risk assessment questionnaires, providing one or more biosamples for biomedical analysis, and/or providing one or more biometric measurements; scoring, ranking, and/or grading the biometric data and/or the health risk assessment questionnaire for one or more health risks; analyzing the biosample for one or more biomedical parameters; analyzing the scored health risk assessment questionnaire and/or the biometric parameters and/or the biometric parameter and determining a Health Score to assess for presence or risk of disease; and optionally providing one or more additional incentives to the one or more participants to maintain over a period of time a predetermined Health Score and/or improve the actual Health Score from test to test toward or beyond a predetermined Health Score.

In yet another embodiment of the present invention, a computer-implemented apparatus, method, program, and/or system for providing aggregated information to a health care insurance participant is provided. The apparatus, method, program, and/or system comprises creating a database of information for one or more participants of the health care insurance plan, wherein the database comprises a plurality of disparate data fields containing data obtained by providing a health risk assessment questionnaire to the one or more participants; scoring, ranking, and/or grading the health risk assessment and/or the biometric analysis for one or more health risks; obtaining a biosample from the one or more participants and analyzing the biosample for one or more biomedical parameters; analyzing the scored health risk assessment questionnaire, the biometric parameters, and/or biomedical parameters and determining a Health Score in connection with an incentive program; and calculating the incentive information based on the Health Score and the incentive program. In yet another embodiment, the computer-implemented apparatus, method, program, and/or system further comprises selecting a sort criterion for organizing at least a portion of the plurality of disparate data fields for the one or more participants according to the sort criterion; formatting the organized portion of the plurality of disparate data fields in a presentable report; and presenting the report to the participant.

In one embodiment of the present invention, an apparatus, method, program, and/or system of altering behavior of a participant in a health care insurance plan is provided. The apparatus, method, program, and/or system comprises offering one or more incentives to the participant to complete a health risk assessment questionnaire, to complete a biometric measurement analysis, to provide a biosample for biomedical analysis; scoring, ranking, and/or grading the health risk assessment and/or the biometric analysis for one or more health risks and the biometric analysis; analyzing the biosample for one or more biomedical parameters; analyzing the scored health risk assessment questionnaire, the biometric parameters, and/or the biomedical parameters and determining a Health Score to assess for presence or risk of disease; and optionally providing one or more additional incentives to the one or more participants to alter the behavior of the participant to achieve, maintain, and/or improve the Health Score and/or one or more parameters making up the Health Score over a period of time.

In yet another embodiment, the financial incentive comprise a contribution discount, a lower deductible as compared to non-participants, or a credit to a health spending account linked to the participant's health care insurance plan.

In still another embodiment, the apparatus, method, program, and/or system further comprises calculating financial incentive information in accordance with an incentive program, including, for example, an incentive program based on incentives used in conjunction with the Health Score of a participant and/or one or more parameters of a Health Score.

In still another embodiment, the step of completing a health risk assessment questionnaire, completing a biometric measurement analysis, and/or providing the biosample for biometric analysis is for the purpose of categorizing the participant under assessment for purposes of enrollment in a clinical trial, on the basis of the health risks results, the biometric parameters results, and/or biomedical results.

In yet another embodiment of the present invention, the step of completing a health risk assessment questionnaire, completing a biometric measurement analysis, and/or providing a biosample for biomedical analysis is for the purpose of categorizing the participant under assessment for purposes of suggesting a type of therapeutic treatment on the basis of the health risks results, the biometric parameters results, and/or biomedical results.

In yet another embodiment, the apparatus, method, program, and/or system further comprises an employer determining in advance of determining a Health Score the incentives used in an incentive program. Illustratively, in one model, an employer sets an incentive of a 20% contribution discount for taking one or more tests used to calculate a Health Score. The following year or so, a Health Score can be set that has to be achieved or exceeded to maintain the 20% contribution discount. In another example, an incentive can be provided to improve a Health Score from test to test after a baseline Health Score is determined. For example, in an incentive program based on 100 points, with 100 being perfect health and zero being failing health, incentives can be based on improving the Health Score by a fraction of a point or by a full point or by multiple points. Illustratively, an incentive can be based on an improvement of a 100 point Health Score of, for example, an improvement of about 0.1 points, 0.25 points, 0.5 points, 0.75 points, 1 point, 1.25 points, 1.5 points, 1.75 points, 2 points, 2.5 points, 3 points, 3.5 points, 4 points, 4.5 points, 5 points, 5.5 points, 6 points, 6.5 points, 7 points, 7.5 points, 8 points, 8.5 points, 9 points, 9.5 points, 10 points, 11 points, 12 points, 13 points, 14 points, 15 points, 16 points, 17 points, 18 points, 19 points, 20 points, 21 points, 22 points, 23 points, 24 points, 25 points, 26 points, 27 points, 28 points, 29 points, 30 points, 31 points, 32 points, 33 points, 34 points, 35 points, 36 points, 37 points, 38 points, 39 points, 40 points, 41 points, 42 points, 43 points, 44 points, 45 points, 46 points, 47 points, 48 points, 49 points, 50 points, 51 points, 52 points, 53 points, 54 points, 55 points, 56 points, 57 points, 58 points, 59 points, 60 points, 65 points, 70 points, 80 points, 85 points, 90 points, 95 points, or 100 points. These points can vary from about 1% to about 20%, or more, depending on the incentive program implemented. Furthermore, an incentive can be based upon a percentage improvement in a Health Score of, including, for example, about 0.001%, 0.01%, 0.1%, 0.5%, 1%, 1.5%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, 10.25%, 10.5%, 10.75%, 11%, 11.25%, 11.5%, 11.75%, 12%, 12.25%, 12.5%, 12.75%, 13%, 13.25%, 13.5%, 13.75%, 14%, 14.25%, 14.5%, 14.75%, 15%, 15.25%, 15.5%, 15.75%, 16%, 16.25%, 16.5%, 16.75%, 17%, 17.25%, 17.5%, 17.75%, 18%, 18.25%, 18.5%, 18.75%, 19%, 19.25%, 19.5%, 19.75%, 20%, 21%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95%, or 100%. These percentages can vary from about 1% to about 20%, or more, depending on the incentive program implemented.

In yet another example, incentives can be provided for submitting verification from a participant's doctor that the participant is adhering to a prescribed therapy including, for example, taking prescribed medication, maintaining a dietary or behavioral change, and/or completing an exercise regime.

In another embodiment, the incentive program provides for increased incentives for maintenance and/or improvement in the participants Health Score over a period of time, including, for example, a period of time of about a week, about a one month, about two months, about three months, about four months, about five months, about six months, about seven months, about eight months, about nine months, about ten months, about eleven months, or about twelve months, or more.

In yet another embodiment of the present invention, an apparatus, method, program, and/or system of lowering health care insurance claim payouts through a financially based incentive program is provided. The apparatus, method, program, and/or system comprises offering one or more incentives to a participant of the health care insurance to complete a health risk assessment questionnaire, to complete a biometric measurement analysis, and/or to provide a biosample for biomedical analysis; scoring, ranking, and/or grading the health risk assessment and/or the biometric analysis for one or more health risks and/or the biometric parameters; analyzing the biosample for one or more biomedical parameters; analyzing the scored health risk assessment questionnaire, the biometric parameters, and/or the biomedical parameters, and determining a Health Score to assess for presence or risk of disease; and optionally providing one or more additional incentives to the one or more participants to improve and/or maintain their Health Score and/or one or more parameters making up the Health Score over a period of time.

In another embodiment of the present invention, an apparatus, method, program, and/or system of administering a financially based incentive health care insurance program is provided. The apparatus, method, program, and/or system comprises offering one or more incentives to a participant of the health care insurance program to complete a health risk assessment questionnaire, complete a biometric measurement analysis, and/or provide a biosample for biomedical analysis; scoring, ranking, and/or grading the health risk assessment questionnaire and biometric parameters for one or more health risks; analyzing the biosample for one or more biomedical parameters; analyzing the scored health risk assessment questionnaire, the biometric parameters, and/or the biomedical parameters and determining a Health Score to assess for presence or risk of disease; and optionally providing one or more additional incentives to the one or more participants to improve and/or maintain their Health Score and/or one or more parameters making up the Health Score over a period of time.

In another embodiment of the present invention, an apparatus, method, program, and/or system of providing incentives to a participant of a health care insurance program based on the status of a Health Score is provided. The apparatus, method, program, and/or system comprises administering to the participant a health risk assessment questionnaire and/or a biometric measurement analysis, and/or taking a biosample from the participant for biometric analysis; scoring, ranking, and/or grading the health risk assessment questionnaire and/or biometric analysis for one or more health risks; analyzing the biosample for one or more biomedical parameters; analyzing the scored health risk assessment questionnaire, the biometric parameters, and/or the biomedical parameters and determining a Health Score in connection with an incentive program; and calculating incentive information in accordance with the incentive program.

In another embodiment of the present invention, an apparatus, method, program, and/or system for providing a financial incentive to a participant of a health care insurance plan for completing a risk assessment questionnaire, completing a biometric measurement analysis, and/or providing a biosample is provided. The apparatus, method, program, and/or system comprises offering one or more incentives to the participant to complete a health risk assessment questionnaire and/or biometric measurement analysis, and/or to provide a biosample for biomedical analysis; scoring, ranking, and/or grading the health risk assessment and/or the biometric analysis for one or more health risks; analyzing the biosample for one or more biomedical parameters; analyzing the scored health risk assessment questionnaire, the biometric parameters and/or the biomedical parameters and determining a Health Score in connection with an incentive program; and calculating incentive information in accordance with the incentive program.

In another embodiment of the present invention, an apparatus, method, program, and/or system of providing a financial incentive plan to a business or organization in connection with a health care insurance plan administered to employees of the business is provided. The apparatus, method, program, and/or system comprises providing to the business a service of providing a health risk assessment questionnaire and/or a biometric measurement analysis to one or more participants in the health care insurance plan, and scoring, ranking, and/or grading the health risk assessment questionnaire and/or biometric parameters for one or more health risks, obtaining a biosample from the one or more participants and analyzing the biosample for one or more biomedical parameters, analyzing the scored health risk assessment questionnaire, the biometric parameters, and/or biomedical parameters and determining a Health Score; and calculating an incentive based on the Health Score and an incentive program.

In another embodiment of the present invention, an apparatus, method, program, and/or system of providing incentive information to a participant of a health care insurance plan associated with achieving, maintaining or improving a Health Score is provided. The apparatus, method, program, and/or system comprises providing a health risk assessment questionnaire and/or biometric measurement analysis to one or more participants in a health care insurance plan; scoring, ranking, and/or grading the health risk assessment and/or the biometric analysis for one or more health risks; obtaining a biosample from the one or more participants and analyzing the biosample for one or more biomedical parameters; analyzing the scored health risk assessment questionnaire, the biometric parameters, and/or biomedical parameters and determining a Health Score in connection with an incentive program; and calculating incentive information based on the Health Score and the incentive program.

In another embodiment of the present invention, an apparatus, method, program, and/or system of providing incentives to a participant of a health care insurance plan for achieving, maintaining and/or improving a Health Score is provided. The apparatus, method, program, and/or system comprises providing a health risk assessment questionnaire and/or biometric measurement analysis to the participant; scoring, ranking, and/or grading the health risk assessment and/or the biometric analysis for one or more health risks; obtaining a biosample from the participant and analyzing the biosample for one or more biomedical parameters; analyzing the scored health risk assessment questionnaire, the biometric parameters, and/or biomedical parameters and determining a Health Score in connection with an incentive program; and calculating an incentive based on the Health Score and the incentive program.

In another embodiment of the present invention, incentives are provided only to individuals that have a preferred status acquired by, for example, participating in at least one of: completing a health-risk assessment questionnaire, completing a biometric measurement analysis, and/or providing a biosample for biomedical analysis, and/or meeting certain criteria such as, for example, maintaining, improving, and/or achieving a predetermined Health Score. Illustratively, a preferred status would make an individual eligible for one or more benefits or incentives. A benefit can include, for example, a financial or monetary reward, merchandise, a coupon, a voucher, a prize, a ticket to an entertainment or sporting event, a travel award, accruing vacation or time off from work, a discount on a good or service, a membership discount, a contribution discount, a lower deductible as compared to non-participants, or a credit to a health spending account linked to the participant's health care insurance plan. The availability of such benefits may expire, for example, after a certain length of time or if the individual fails to meet the criteria set out for the benefit.

Other incentives that may be used in the present invention include such things as, for example, after every month of preferred status in the program, the participant may receive points that can be used to obtain a benefit or receive a number of chances in a sweepstakes, which number in one embodiment is equal to the number of months of continuous preferred status. In one example, the points or prize in a sweepstakes associated with such an incentive program can used in conjunction with, for example, monetary awards; retail discounts or gift certificates; trips; health club memberships; professional services, such as, for example, legal, dental, or medical services; entertainment awards; electronics; clothing; access to medicines, including prescription medications, medical devices, equipment and supplies and/or specified treatment; discounted and/or free access to medical plans and medical coverage; enhancements to medical plans and/or medical coverage at discounted or reduced or no cost; specified types of educational services such as language lessons, tutoring/mentoring; and other social services and any other goods and/or services that may be deemed appropriate or desirable for specified periods of time and other benefits and rewards that may be desired by participants or others. As an alternative, an individual with a preferred status may receive a percentage discount for each time period, such as a month, a calendar quarter, or a year of continuous preferred status, up to a maximum discount, among other variations. The redemption of points and/or prizes can be awarded through direct redemption and/or through random drawing sweepstakes drawings, for example, and may result in the entitlement to a variety of free or discounted services being provided to participants and/or premium levels of service being provided over and above standard services.

In connection with professional services, rewards may be redeemed, for example, for individual tasks. Examples of such tasks include the preparation of a will by an attorney, the conduct of a routine examination by a dentist, a routine medical examination by a physician or other tasks and activities. It will be appreciated that the services of assistants working under the supervision of a professional, such as paralegals, dental hygienists and medical technicians and others may be included in the professional services obtained. Rewards may also include no cost or discounted preferred status or status as a patient in medical and other professional services practices that charge a fee for such status. Preferred status may mean, for example, reduced or no waiting to see a physician or other professional or to speak to a professional, or priority in scheduling appointments.

Incentive programs detailing benefits of preferred status may be provided to individuals and include such factors as the Health Score necessary to achieve a certain preferred status, number of months required to obtain preferred status, and/or the type of the benefit and/or quantity of the benefit.

The redemption of points and/or prizes that may be awarded through direct redemption, through random drawing sweepstakes drawings and may result in the entitlement to a variety of free or discounted services being provided to participants and/or premium levels of service being provided over and above standard services. Prizes in the context involving sweepstakes drawings and/or bonus rewards, whether random or planned may include a prescribed number of hours of services being provided to recipients during a prescribed period of time, possibly within a prescribed period of time, as one example. The participants may also be able to redeem previously earned points in exchange for various forms of services for themselves and/or for other identified parties including family members and other qualified participants and even other specified third party beneficiaries that may be deemed acceptable in various circumstances. By way of example, the services furnished may be legal services as described herein. The tasks and activities such as legal services may be limited in various ways, including by field and/or by nature of the task or activity, and by number of hours and by other means. A sweepstakes may be provided in which points are redeemed for entries, and/or consumers are automatically entered, with a certain amount of prepaid professional services being received as a reward. The amount may be expressed as a task, time and/or value or parameter.

In another aspect of the present invention, incentives can be provided to a participant for preventive services or care. For example, incentives can be provided to a participant for obtaining immunization against a pathogen, such as, for example, influenza, polio, tetanus, or hepatitis; blood pressure screening; cholesterol screening; cancer screening, such as, for example, colon, breast cervical or prostate screening; and/or a rectal examination.

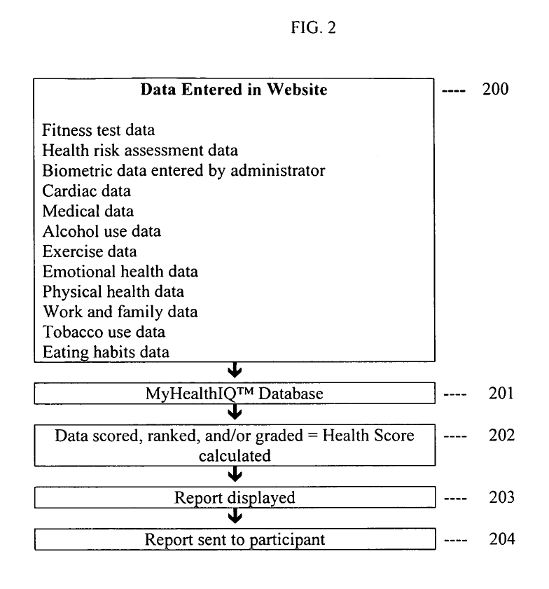

Referring to FIG. 2, in one embodiment of the present invention, data are entered in a website into a database 200. Such data in entered into a database 201 includes, for example, fitness test data, health risk assessment data, biometric data entered by an administrator, cardiac data, cancer data, medical data, alcohol use data, exercise data, emotional health data, physical health data, work and family data, tobacco use data, and/or eating use data. From this data, points, rankings, and/or ratings are calculated 202 that may be used to determine a Health Score that may be used to determine a Health Score, and a report is generated or displayed 203 and provided to a participant 204 and/or administrator and/or sponsor and/or sponsor.

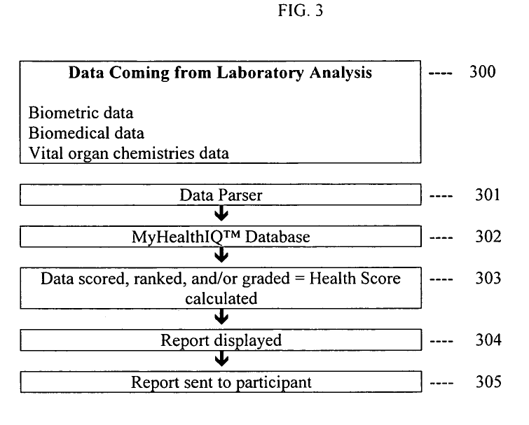

Referring to FIG. 3, in yet another embodiment of the present invention, data coming from laboratory analysis 300 is parsed 301 and entered into a database 302. Such data includes, for example, biometric data, biomedical data, and/or vital organ chemistries data. Once the data are parsed and entered into a database, points, rankings, and/or ratings are calculated 303 that may be used to determine a Health Score, and a report is generated or displayed 304 and provided to a participant 305 and/or administrator and/or sponsor and/or sponsor.

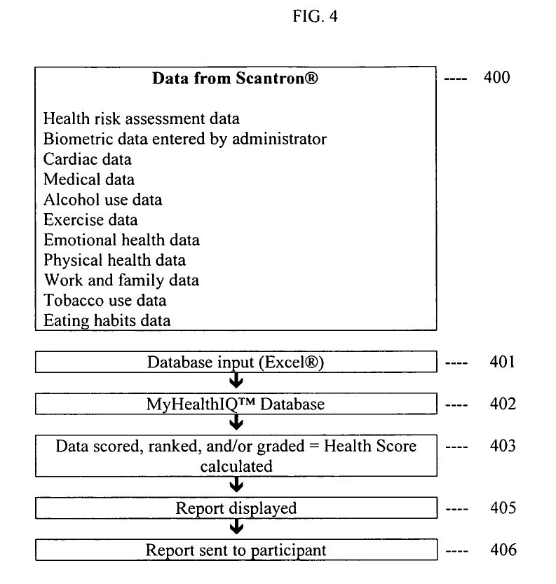

Referring to FIG. 4, in still another embodiment of the present invention, data from a Scantron® (or its equivalent) 400 is entered into a spreadsheet 401, such as, for example, an Excel® spreadsheet, and then entered into a database 402 for further analysis. Such data includes, for example, health risk assessment data, biometric data entered by an administrator, cardiac data, cancer data, medical data, alcohol use data, exercise data, emotional health data, physical health data, work and family data, tobacco use data, and/or eating use data. From this data, points, rankings, and/or ratings are calculated 403 that may be used to determine a Health Score, and a report is generated or displayed 404 and provided to a participant 405 and/or administrator and/or sponsor and/or sponsor.

In another embodiment of the present invention, a website is provided to input, compute, and/or manage health related data from one or more participants of a health care system or program. For example, the website can be sectioned or divided to manage users, data input, and/or data analysis. In one section, for example, a site can provide users with, for example, a corporate brochure explaining the health program, sample reports, content regarding the health evaluation tests and biometric analysis, and/or frequently asked questions pertaining to the apparatus, methods, programs and/or systems of the present invention. Another site can be provided where the participants of the system or program can, for example, manage their profile, take a self-reported test, review test status, view reports, schedule test, and/or view articles associated with their health risks. Another site can be dedicated to managing the health system or program.

In one embodiment of the present invention, three levels of administration are provided to manage the health system or program. Illustratively, at the highest level of access, authority to access all the data contained within the health system or program is provided. Such access will allow a user to be able to create and/or edit test and group administrators, as well as participants; view all reports; complete quality assurance analysis; edit all data coming from laboratory analysis, Scantrons®, and website; and/or add and/or distribute (for example, via e-mail) health risk articles and other information to participants. In the next level of access, authority to view all reports for a particular group in which the person is associated with is provided, as well as authority to schedule tests and track participant attendance. The next level of access provides authority to add and/or edit a participant's profile; edit data coming from laboratory analysis; enter fitness test data, Scantrons® data, and/or website data; and/or view all reports.

In another aspect of the present invention, a database can be provided that consists of, for example, one or more tables used to lookup the rating for each participant's results; one or more tables to hold the results from various test; one or more tables to hold the group, administration, and participant information; one or more login tables with access levels for all the users; one or more test status tables; and/or one or more tables holding the points, rankings, and/or rating for each participant. Illustratively, when data are received from various sources, it can be processed through a stored procedure, software program or algorithm (for example, an incentive algorithm) that can calculate the points, rankings, and/or ratings for each participant and insert this information into a table. If any data is incorrect and needs to be updated, for example, in a quality assurance analysis (or at any other given time), the stored procedure, software program and/or algorithm can be called and the points, rankings, and/or ratings can be updated. In another aspect of the present invention, when a participant and/or administrator and/or sponsor views a report, this information can come directly from a points, rankings, and/or ratings table, for example. Self reported data may also be included. Furthermore, a table that holds all the participant's answers to the questions for the self reported section can be provided for viewing by the participant and/or the administrator and/or the sponsor. In yet another section, overviews of the health system or program, corporate benefits, participant benefits, and the various tests and assessment tools can be provided. In one embodiment, this section can be used as a sales tool for prospective clients, including, for example, corporations, universities, businesses, government agencies, and/or other entities, including program participants, employees and/or associates. In another embodiment, a section for employees of a client, for example, can be provided for those that have a partnership with the health system or program. Illustratively, a participant coming to the site for the first time creates a profile with a username and password. Once logged in, participants have the ability to create, view and/or edit their profiles, view their test status and/or results (for example, view data and/or results from biosample data analysis, biometric analysis, self-reported data, and/or fitness data), schedule and/or take a health assessment questionnaire online, view reports once the tests are completed (for example, view reports based on blood analysis, biometric analysis, fitness analysis, health assessment questionnaire analysis, which, in one embodiment, make up a global health assessment profile for the participant), and/or view articles related to health risks, including, for example, those identified in their health screening. In the area of managing the health system or program, in one embodiment of the present invention, three level of management can be set up that have different capabilities. Such capabilities can be defined by the access level of each username and password. Management, for example, can view and print reports, access and update data regarding clients and participants, and/or manage tests.

A database may also in one embodiment of the present invention include a list and/or a table of a health risk, and/or an associated measurement of the health risk. The health risk measurement may be an incidence of disease associated with a particular health risk, and/or a ranking of a particular health risk with respect to frequency and/or significance, and/or a weighting associated with a particular health risk, associated with frequency and/or significance of the health risk. The health risk may be associated with, for example, a particular population. In one embodiment, the measurement of health risk associated with the population may be available when the database is initially created. That is, what health risks currently exist in the population, and/or are known to exist. Alternatively, the measurement of a health risk associated with the population is created in response to analysis of the health-related information, and is updated as deemed appropriate. In addition, the database may include a list of health risk associated with a second population. The second population may be a national measurement of, for example, incidence of a particular health risk, and/or the incidence of the health risk in analogous parts of the country, and/or analogous working environments of the population members. The health risk may be, for example, a known disease, heart attack, or other form of health risk. The health risk measurement may be further categorized based on age, gender, type of work, location (for example, area of the world, country, and/or state).

A database of the present invention may also include a list and/or table that includes health care costs associated with an established health risks. Health care costs may be based on the health care cost associated with the participant population, and/or a second population (for example, a national average). The health care cost may also be associated with a particular health risk. In addition, the health care cost associated with the population will be monitored and updated accordingly. For example, information associated with health characteristics, for example, the medical claims, drug claims, absenteeism, number of days in a medical facility and/or visits to a doctors office may be correlated to a health risk of a participant and used to update the health care cost of the population associated with that health risks in particular, and/or health care cost of the population as a whole.

A database in another aspect of the present invention may also include one or more lifestyle change initiatives. For example, one or more change inducing technique associated with a modifiable lifestyle characteristic may be identified. Illustratively, the lifestyle change inducing technique may be an intervention method targeted to influence a participant to alter their modifiable lifestyle characteristic, for example, reduce the number of cigarettes smoked, and/or alcoholic beverages consumed. In addition, a success characteristic may be associated with the lifestyle change inducing technique (or intervention method). For example, providing educational literature to smokers in an attempt to get them to reduce or quit smoking may be found to be 30% effective in achieving the desired smoking reduction. Therefore in one embodiment, the success characteristic may be established to be 30%. In one embodiment, the success characteristic may be established in response to the success of the lifestyle change inducing technique when applied to a second population. That is, the success characteristic may be a national average for example. However, a success characteristic of the lifestyle change inducing technique may be established based on applying the change inducing technique to the established population, or a portion thereof, and monitoring and recording the results. Therefore the success characteristic may be specific to the population, and may even be specific to the participant population.

Health related information useful in the present invention may be established using one or more techniques. These techniques may include, for example, manual data entry, electronic integration with existing databases, web-enabled data entry, voice communications, personal interviews, and/or feedback from questionnaires. In one embodiment, electronic integration with existing databases may be used to establish the information. For example, a hospital may have a database of medical information associated with a specific member, for example, medical claims, medical analysis, etc. The repository being established may be able to access identified hospital databases to acquire information associated with a specific member. Alternatively, during or after a medical analysis is performed, or medical claim issued, the medical information may be electronically communicated to the database, and/or a manager of a database. For example, an e-mail from a hospital may be delivered to a manager of a database, who may then manually and/or in an automated manner, enter the information into the database. Alternatively, the hospital database may have the ability to automatically communicate with the database and send the desired health related information to the database. For example, whenever the hospital records are updated for a particular participant, the hospital computing system may automatically send an electronic communication to the database to update the database appropriately. In one embodiment, drug claims from either a hospital or drug provider may be electronically communicated to the database, and/or manager of the repository. In one embodiment, a web site may be established such that a specific participant may be able to electronically communicate health-related information to the database. For example, a participant may access a web site, and manually enter health-related information. Alternatively, the participant may send an e-mail containing health related information to the repository or a manager of the repository. In addition, some information may be manually entered into the repository. For example, if paper copies of medical and drug claims are received, then a person may manually enter the health related information specific to the identified participant, into the database. In addition, electronic searches may be done to determine the participant's relevant family members with respect to establishing a family history. The medical records of the relevant family members may be requested from the participant, and/or associated medical facility, and/or automatically acquired through electronic communication with a second database containing the desired information. For example, upon receiving consent from the participant, a computer system may automatically connect to a second database, for example, a medical facility, and access the database to acquire the relevant information regarding the members family history. In addition, information may be solicited and received from the participant. For example, specific health information may be received by making telephone calls to specific participants, asking specific health related questions, and then entering the received information into the repository. In addition, questionnaires may be established, and then sent to specific participants. The participants may then respond with feedback which is then manually entered into the database. In one embodiment, additional questionnaires may be sent to specific participants in response to the answers provided on one or more prior questionnaires. The feedback from these additional questionnaires may then, for example, be manually entered into the repository.

In one embodiment of the present invention, the database of health related information may be used to manage an incentive program. The incentive program, for example, may be managed by a corporation, for the employees of the corporation. Alternatively, the health care program may be managed by a health care organization, for the employees of one or more corporations unrelated to the health care organization. Alternatively, or in addition to, the health care program may be for participants of the general public, for example, people who pay to be part of the health care program.

The health care program in yet another embodiment may be managed by establishing cause and effect relationships between lifestyle characteristics and a health risk. In one embodiment, the health risk includes modifiable health risk, and the lifestyle characteristics are associated with the modifiable health risk. In one embodiment, the modifiable health risk may be established by a process separate from this invention, for example, independent medical research, and the results of the research may be incorporated into a database of health related information. For example, the independent medical research may indicate which health risks are modifiable, and what lifestyle characteristics contribute to the health risk, and in what manner the characteristics contribute. For example, the study may indicate that lung cancer is a modifiable health risk. In addition, the study may indicate that smoking contributes to lung cancer, for example, a member smoking has a 60% chance of contracting lung cancer. In another embodiment, the modifiable health risks may be determined (or modified) through analysis of the health information of the database. Other lifestyle characteristics may be included in the analysis, such as, for example, age, gender, country, and/or employment type. In addition, there may be several lifestyle characteristics that contribute to the modifiable health risk, and the combination of some lifestyle characteristics may have an impact on the modifiable health risk in a manner different from simply the additive effect of the individual lifestyle characteristics. In this environment, that is, when the results of a correlation between lifestyle characteristics (for example, modifiable lifestyle characteristics) and modifiable health risks are developed by an external source, the results may be stored in a database. A correlation of lifestyle characteristics and modifiable health risk may be performed as a result of the analysis of the health related information of the database for use in the present invention. The correlation between lifestyle characteristics and modifiable health risk may be used, for example, to perform analysis of the participant population, or a portion thereof. In addition, once correlation results are established, they may be modified in light of the analysis of the population, or portion thereof. For example, a national survey may indicate a person who smokes has a 60% chance of contracting lung disease. However, as time goes on, analysis of the population may be used to modify the stored correlation to customize the correlation to the participant population. Alternatively, a database of health related information may be used to establish the relationship between a lifestyle characteristic and a health risk. For example, in one embodiment, the health characteristics of a participant may be analyzed to determine what health risks the participants of the population, or a portion thereof, exhibit. Then the lifestyle characteristics of the participants may be correlated with the health risk to establish baseline correlations of health risk and lifestyles. Illustratively, the result of the baseline correlations may indicate 60% of the population that has lung cancer actually smokes, as compared to a national metric indicating that 70% of the population that has lung cancer actually smokes. This type of information may be further analyzed to indicate what the chances are that if a participant smokes, they will contract lung cancer. In addition to this, these baseline correlations may be further refined as additional information and analysis of the participant population is performed.

In yet another aspect of the present invention, the apparatuses, systems, programs, and/or methods provides an analysis and/or a database that includes, for example, a correlation of lifestyle (or behavior) changing initiatives with lifestyle characteristics to determine the impact one or more lifestyle changing initiatives has on changing a lifestyle. For example, the lifestyle changing initiative may include sending intervention material (for example, educational material) to a smoker indicating the health risk of smoking, in an attempt to get the smoker to reduce or quit smoking (that is, change the lifestyle characteristic). The correlation may also include a projected success characteristic of the lifestyle changing initiative. Some lifestyle changing initiatives may be targeted for the whole population as opposed to an identified portion of the population. In addition, the research may indicate that if the company subsidizes a designated healthy meal, that the overall nutrition of the population is improved even further. Lifestyle changing initiatives may include providing (or making available) health related information to the members such as health books, including nutrition and cook books, health related audio or video recordings, providing recommended literature, providing telephone counseling, initiating a general health related questionnaire and a targeted health related questionnaire where appropriate, providing a newsletter including health related issues and/or program progress, identification and/or subsidizing of healthy (or healthier) foods in the cafeteria and vending machines, sponsoring walks, runs, health fairs, health screenings during, or after hours, including blood pressure screenings, mammography, sigmoidoscopy, subsidizing health club participation costs, providing cash incentives based upon program participation (such as reduced premiums), provide or subsidizing nicotine patches, establishing smoke awareness programs and smoke free policies, establishing wellness teams, providing lactating rooms for nursing mothers, establishing safety programs, fostering and/or demonstrating management program support, providing active wear with a health related logo, provide on site presentations, perform training meetings to human resource personnel (including communicating the initiatives and implementation techniques), communicating the business case to the facilitators of cultural change within the population, for example, managers and line supervisors in a corporation, communicate to employees benefits of the health program and benefits of good health in general.

In another embodiment of the present invention, health characteristics may be analyzed to track health care cost. For example, medical and drug claims may be analyzed to determine general trends in the cost of medical services, facilities, and/or associated treatments. In addition, the medical and drug claims, absenteeism, number of doctor visits, and number of days in a medical facility may be analyzed to determine the overall health care cost of the participant population, or the cost associated with a particular health risk, or a particular portion of the participant population.

In yet another aspect of the present invention, a current and/or potential sponsor (for example, a corporate client) is provided with access to a website that contains information pertaining to the health system and/or program, such as, for example, a corporate brochure, sample reports, case studies, and/or participant brochures. Such information can be used to evaluate the merits of such a system and be used to influence the decision of the sponsor to institute such a program for its employees, for example. Current and/or potential participants of the system or program can be provided with access to participant brochures, incentive information, and/or sample reports that describe the various aspects of the health system or program. This information can be useful in influencing the decision of a potential participant to partake in the program in same way. Overviews of self-reported tests, biometric tests, biosample tests, and/or fitness tests can also be provided as a general information to those who access the website to provide information pertaining to the health system or program.

In another aspect of the present invention, a client administrator provides client management. Client management includes performing such tasks as, for example, creating client setup, including, for example, setting client requirements, and creating client identification; creating client profile, including, for example, editing the client profile; generating client reports, including, for example, providing an application summary, a comparison report, and/or participation statistics; quality assurance, including, for example, error checking; fulfillment, including, for example, creating printed reports; and/or scheduling, for example, tests and/or test times; tacking attendance, and/or scheduling a test.

In yet another embodiment of the present invention, a test administrator provides participant management. Participant management includes performing such tasks as adding new participants to the system; scheduling, for example, tests and/or test times; tracking attendance; providing articles; managing test information and data; managing the reported of test results; and/or managing the viewing of profiles.

In yet another embodiment of the present invention, the apparatuses, systems, programs, and/or methods come in the form of a kit or package containing one or more incentive health care insurance programs of the present invention. The kit or package can also contain one or more sets of instructions for use or administration of the program or programs.

In another aspect of the present invention, an incentive is determined by establishing an age-based measurement of a health risk; and/or establishing a gender based measurement of a health risk.

In yet another aspect of the present invention, an incentive is determined by establishing a health care cost characteristic associated with a health risk.

The methods, systems, programs, tasks, activities, transactions and events that are described herein may variously that take place offline, online, over telephone networks, in particular physical locations and in other ways, including as described herein. All of the programs described herein, including one or more component elements of all of the programs may be interchanged and otherwise commingled in and with other programs and other parts of other programs that have been described previously.

In another aspect of the present invention, the methods, systems, and/or programs may be executed in a variety of systems, including a variety of computing systems and electronic devices under a number of different operating systems. In one embodiment of the present invention, the computing system includes a portable computing system such as a notebook computer, a palmtop computer, a personal digital assistant, a telephone or other electronic computing system that may also incorporate communications features that provide for telephony, enhanced telephony, messaging and information services. However, the computing system may also include, for example, a desktop computer, a network computer, a midrange computer, a server system or a mainframe computer. Therefore, in general, the present invention can in one embodiment be executed in a computer system that performs computing tasks such as manipulating data in storage that is accessible to the computer system. In addition, the computer system may include at least one output device and at least one input device.

In yet another aspect of the present invention, programs, systems, and/or methods are provided for encouraging the performance of tasks in a particular manner and/or at a particular time, or before or after a certain time. The tasks and activities that may be performed include, for example, providing, administering, offering, evaluating, scoring, ranking, grading, and/or analyzing a health risk assessment questionnaire; providing, administering, offering, evaluating, scoring, ranking, grading, and/or analyzing a biometric measurement analysis; providing, evaluating, scoring, ranking, grading, and/or analyzing a biosample for biomedical analysis; scoring, ranking, and/or grading a health risk assessment questionnaire, a biometric parameter, and/or biomedical parameter; determining a Health Score to assess for presence or risk of disease from a scored, ranked, and/or graded health risk assessment questionnaire, biometric parameter, and/or biomedical parameter; offering of incentives; maintaining, improving, and/or achieving a particular Health Score; and others that will influence the generation of incentives, motivation, and participation from others.

Illustratively, a Health Score is scored, ranked, and/or graded based on a 100 point scale and can include health risks such as, for example, tobacco use (24/100), blood pressure (16/100), weight control (12/100), body fat (12/100), total cholesterol (4/100), high density lipoprotein cholesterol (4/100), total/high density lipoprotein cholesterol ratio (4/100), low density lipoprotein cholesterol (4/100), triglycerides (8/100), serum glucose level (8/100), and glutamyltransferase level (4/100). Each of these are weighted and assigned a point value with a total of 100 points. The weighting is indicated in parenthesis and is based on the impact on the health of the participant or a particular health risk associated with the parameter. This can be determined in one embodiment by referencing nationally published data. After the tests are completed and a Health Score determined, a report can be generated as shown below in Table No. 1

TABLE NO. 1
My Health IQ Score
Participant's Health Score

| Risk Category | Test Results | Score/Weight | Risk |
|---|---|---|---|
| Tobacco Use | You said you quit over 4 years | 18/24 | Minimal |
| | ago | | |
| Blood Pressure | Your blood pressure is 135/90 | 12/16 | Moderate |
| Weight Control | Your Body Mass Index | 6/12 | Minimal |
| | calculation is 26.9 | | |
| Body fat | Your body fat is 27% | 3/12 | Minimal |
| Total Cholesterol | Your cholesterol reading is | 3/4 | Minimal |
| | 208 | | |
| High density lipoprotein | Your high density lipoprotein | 4/4 | Minimal |
| cholesterol | cholesterol is 52 | | |
| Total/high density | Your current ratio is 4.7 | 2/4 | Moderate |
| lipoprotein cholesterol | | | |
| ratio | | | |
| Low density lipoprotein | Your low density lipoprotein | 4/4 | Minimal |
| cholesterol | cholesterol is 85 | | |
| Triglycerides | Your triglycerides level is 189 | 6/8 | Minimal |
| Glucose | Your glucose level is 98 | 8/8 | Minimal |
| Glutamyltransferase | Your glutamyltransferase level | 2/4 | Minimal |
| | is 56 | | |
| | | Score: 74/100 | |

On a scale of 100, this particular participant has a Health Score of 74. This can be concluded to be an excellent Health Score based on medically nationally recognized criteria. This means, for example, that there is a minimal risk of developing lifestyle related disease, chronic illness, or excess medical claims that could be preventable. The individual results and parameters that make up the composite Health Score can be based, for example, on the following criteria:

TABLE 2
Blood Pressure

| | Extreme | High | Medium | Moderate | Minimal |
|---|---|---|---|---|---|
| | (0 points) | (6 points) | (12 points) | (18 points) | (24 points) |
| Systolic | 160 or more | 146-159 | 131-140 | 121-130 | 120 or less |
| Diastolic | 100 or more | 91-99 | 86-90 | 81-85 | 80 or less |

The blood pressure reading of the participant was 135/90, which would be assigned a medium risk and 12 points out of 100.

TABLE NO. 3
Weight Control (Body Mass Index)

| Extreme | High | Medium | Moderate | Minimal |
|---|---|---|---|---|
| (0 points) | (6 points) | (12 points) | (18 points) | (24 points) |
| 30.1 or more | 28.1 to 30.0 | 26.1 to 28.0 | 24.1 to 26.0 | 19.0 to 24.0 |
| 18.9 or less | | | | |

The body mass index of the participant of 204 pounds and 73 inches high is calculated to be 26.9 (204 pounds times 703, divided by, 73 inches times 73 inches). This index would be assigned a medium health risk and 12 points out of 100.

TABLE 4
Body Fat Percentage

| | Extreme | High | Medium | Moderate | Minimal |
|---|---|---|---|---|---|
| | (0 points) | (6 points) | (12 points) | (18 points) | (24 points) |
| Males 30 | 31% or more | 27-30% | 23-26% | 20-22% | 19% |
| to 39 | | | | | or less |
| years | | | | | |

The body fat percentage of the participant with a wrist size of 7 inches and a waist size of 36 inches is calculated to be 27%, which would be assigned a high health risk and 6 points out of 100.

TABLE NO. 5
Total Cholesterol

| Extreme | High | Medium | Moderate | Minimal |
|---|---|---|---|---|
| (0 points) | (1 points) | (2 points) | (3 points) | (4 points) |
| 260 or more | 240-259 | 221-239 | 200-220 | 199 or less |

The total cholesterol reading of the participant was 208, and would be assigned a moderate health risk and 3 points out of 100.

TABLE 6
High Density Lipoprotein Cholesterol

| | Extreme | High | Medium | Moderate | Minimal |
|---|---|---|---|---|---|
| | (0 points) | (6 points) | (12 points) | (18 points) | (24 points) |
| Males | 34 or more | 35-39 | 40-44 | 45-49 | 50 or more |

The high density lipoprotein cholesterol level of the participant was 52, which would be assigned a minimal health risk and 24 points out of 100.

TABLE 7
Cholesterol/High Density Lipoprotein Ratio

| | Extreme | High | Medium | Moderate | Minimal |
|---|---|---|---|---|---|
| | (0 points) | (1 points) | (2 points) | (3 points) | (4 points) |
| Males | 7.1 or more | 5.6-7.0 | 4.1-5.5 | 3.4-4.0 | 3.3 or less |

The cholesterol/high density lipoprotein ratio of the participant was 4.7, and would be assigned a medium health risk and 2 points out of 100.

TABLE NO. 8
Low Density Lipoprotein Cholesterol

| Extreme | High | Medium | Moderate | Minimal |
|---|---|---|---|---|
| (0 points) | (1 points) | (2 points) | (3 points) | (4 points) |
| 190 or more or | 160-189 | 130-159 | 100-129 | 99 or less |
| unknown | | | | |

The participant's low density lipoprotein cholesterol level was 85, and would be assigned a minimal health risk and 4 points out of 100.

TABLE NO. 9
Triglycerides

| Extreme | High | Medium | Moderate | Minimal |
|---|---|---|---|---|
| (0 points) | (2 points) | (4 points) | (6 points) | (8 points) |
| 500 or more | 200-499 | 175-199 | 150-174 | 149 or less |

The participant's triglycerides level was 189, and would be assigned a moderate health risk and 6 points out of 100.

TABLE 10
Glucose

| | Extreme | High | Medium | Moderate | Minimal |
|---|---|---|---|---|---|
| | (0 points) | (6 points) | (12 points) | (18 points) | (24 points) |
| Fasting more | 140 | 115-139 | 108-114 | 101-107 | 100 or less |
| than 7 hours | or more | | | | |
| Non-fasting | 152 | 140-151 | 128-139 | 116-127 | 115 or less |
| | or more | | | | |

The participant's glucose level was determined to be 98, and would be assigned a minimal health risk and 24 points out of 100.

TABLE NO. 11
Glutamyltransferase

| Extreme | High | Medium | Moderate | Minimal |
|---|---|---|---|---|
| (0 points) | (2 points) | (4 points) | (6 points) | (8 points) |
| 91 or more | 71-90 | 51-70 | 31-50 | 1-30 |

The participant's glutamyltransferase level was determined to be 56, which would be assigned a medium health risk and 4 points out of 100.

Other blood tests can be performed and the participant can be alerted to lifestyle changed is one of more the parameters fall out of normal range. For example a battery of blood tests is provided in Table No. 12. In this table the normal range for an adult human is indicated and the bodily function or area that is tested.

TABLE NO. 12
Blood Tests and Alert Status

| Risk Category | Normal Range | | Area |
|---|---|---|---|
| Blood urea nitrogen | 6-25 | mg/dl | Kidney |
| Creatinine | 0.6-1.5 | mg/dl | Kidneys |
| Uric Acid | 2.5-7.5 | mg/dl | Liver |
| Bilirubin | 0.1-1.2 | mg/dl | Liver |
| Serum glutamate | 0-41 | U/L | Liver |
| pyruvate | | | |
| transaminase (AST) | | | |
| Serum glutamate | 0.45 | U/L | Liver |
| pyruvate | | | |
| transaminase (ALT) | | | |
| Alkaline | 30-115 | U/L | Liver |
| Phosphatase | | | |
| Protein, total | 6.0-8.5 | g/dl | Kidneys |
| Albumin | 3.2-5.5 | g/dl | Liver |
| Globulin | 2.0-4.5 | g/dl | Blood |
| Calcium | 8.3-10.2 | g/dl | Bones |
| Lactic acid | 100-220 | g/dl | Tissue |
| dehydrogenase | | | |

The invention has been described in an illustrative manner and it is to be understood the terminology used is intended to be in the nature of description rather than of limitation. All patents, published patent applications, and other references described herein are incorporated herein by reference as if they appear in this document in their entirety. Many modifications, equivalents, and variations of the present invention are possible in light of the above teachings, therefore, it is understood that within the scope of the below claims, the invention may be practiced other than specifically described.

1. A method of administering an incentive based health care program, the method comprises:
offering one or more incentives to one or more participants of the health care program, the one or more incentives provided to the one or more participants to perform at least one of completing a health risk assessment questionnaire addressing one or more health risks, completing a biometric measurement analysis addressing one or more biometric parameters, or providing a biosample for biomedical analysis; wherein, if the one or more participants completes the health risk assessment questionnaire, completes the biometric measurement analysis, or provides the biosample, the incentive is awarded to the one or more participants; and if the biosample is provided the biosample is analyzed for one or more biomedical parameters;
scoring, ranking, or grading at least one of the one or more health risks, the biometric measurement analysis, or the one or more biometric parameters to calculate a Health Score; and
notifying the one or more participants of the Health Score.

2. The method of claim 1, wherein the incentive comprises a contribution discount of about 0.1% to about 99%.

3. The method of claim 2, wherein the contribution discount is about 20% or less.

4. The method of claim 1, wherein the incentive is based on a comparison to a medical index of normal range for the one or more health risks, the one or more biometric parameters, or the one or more biomedical parameters.

5. The method of claim 1, further comprising calculating incentive information in accordance with an incentive program.

6. The method of claim 5, wherein the incentive program bases the incentive information on the Health Score of the participant.

7. The method of claim 5, wherein the incentive program bases the incentive information on a comparison to a medical index of normal range with at least one of the one or more health risks, the one or more biometric parameters, or the one or more biomedical parameters.

8. The method of claim 5, wherein the incentive program provides for an incentive for at least one of achieving a predetermined Health Score, improving a Health Score, maintaining a predetermined Health Score, achieving an individual parameter of a Health Score, improving an individual parameter of a Health Score, or maintaining a predetermined individual parameter of a Health Score.

9. The method of claim 1, wherein an additional incentive is provided to the participant after achieving one or more incentives to partake in the incentive based health care program at another time in the future.

10. The method of claim 1, wherein the incentive comprises a monetary reward, merchandise, a coupon, a voucher, a prize, a ticket to an entertainment or sporting event, a travel award, accruing vacation or time off from work, a discount on a good or service, a membership discount, a contribution discount, a lower deductible as compared to non-participants, or a credit to a health spending account linked to the participant's health care insurance plan.

11. The method of claim 1, wherein the incentive comprises a financial reward.

12. The method of claim 1, wherein the Health Score is based on a comparison to a medical index of normal range for at least one of the one or more health risks, the one or more biometric parameters, or the one or more biomedical parameters.

13. The method of claim 1, wherein at least one of the one or more health risks, the one or more biometric parameters, or the one or more biomedical parameters are evaluated in comparison to a medical index of normal range to determine the Health Score.

14. The method of claim 1, wherein the one of the one or more health risks, the biometric parameters, or the biomedical parameters are scored based on an impact on excess health care claims

15. The method of claim 14, wherein the one of the one or more health risks, the one or more biometric parameters, or the one or more biomedical parameters comprises at least one of tobacco use, blood pressure, body weight, body-mass-index, body fat, total cholesterol level, high density cholesterol level, ratio of total cholesterol level to high density cholesterol level, low density cholesterol level, triglyceride level, glucose level, or gamma glutamyltransferase level.

16. The method of claim 1, wherein the one of the one or more health risks, the one or more biometric parameters, or the one or more biomedical parameters are modifiable by the one or more participants within a period of about twelve months or less by at least one of administration of a pharmacological agent, gene therapy, implementation of a behavioral change, implementation of an exercise regime, or implementation of a dietary change.

17. The method of claim 16, wherein the one of the one or more health risks, the one or more biometric parameters, or the one or more biomedical parameters comprises at least one of tobacco use, blood pressure, body weight, body-mass-index, body fat, total cholesterol level, high density cholesterol level, ratio of total cholesterol level to high density cholesterol level, low density cholesterol level, triglyceride level, glucose level, or gamma glutamyltransferase level.

18. The method of claim 16, wherein the pharmacological agent comprises a prescription drug, an over-the-counter drug, a homeopathic agent, an herbal agent, a mineral, or a vitamin.

19. The method of claim 16, wherein the behavioral change comprises implementing an exercise program.

20. The method of claim 16, wherein the dietary change comprises consuming food that is lower in at least one of salt, calories, carbohydrates, protein, fat, cholesterol, or triglycerides.

21. The method of claim 16, wherein the dietary change comprises consuming food that is higher in at least one of minerals, vitamins, dietary fiber, calories, carbohydrates, protein, fat, cholesterol, or triglycerides.

22. The method of claim 1, wherein the one or more biomedical parameter assess vital organ function.

23. The method of claim 1, wherein the biomedical parameter comprises serum concentration of at least one of glucose, blood urea nitrogen, creatinine, uric acid, bilirubin, serum glutamic-oxaloacetic transaminase enzyme, serum glutamate pyruvate transaminase enzyme, alkaline phosphatase, lactic acid dehydrogenase, total protein, albumin, globulin, iron, calcium, phosphorous, sodium, potassium, chloride, high density lipoprotein, triglycerides, total cholesterol, very low density lipoprotein, or low density lipoprotein.

24. The method of claim 23, wherein the biomedical parameter comprises albumin/globulin ratio, total cholesterol/high density lipoprotein ratio, or low density lipoprotein/high density lipoprotein ratio.

25. The method of claim 1, further comprising providing one or more additional incentives to the one or more participants to achieve, maintain or improve their Health Score over a period of time.

26. The method of claim 25, wherein the period of time comprises about thirty minutes to about 5 years.

27. The method of claim 25, wherein the period of time comprises about one hour, two hours, six hours, eight hours, twelve hours, eighteen hours, one day, two days, three days, four days, five days, six days, one month, two months, three months, four months, five months, six months, seven months, eight months, nine months, ten months, eleven months, twelve months, twenty-two months, thirty-six months, forty-eight months, or sixty months.

28. The method of claim 1, further comprising offering to the one or more participants after completing the health risk assessment questionnaire or the biometric measurement analysis, or providing the biosample, information regarding at least one of homeopathic care, self-awareness, preventive care, or medical alerts.

29. The method of claim 1, further comprising reporting to the one or more participants at least one of the one or more biometric or biomedical parameters.

30. The method of claim 29, wherein the reported one or more biometric or biomedical parameters are compared to a medical index of normal range for the one or more biometric or biomedical parameters.

31. The method of claim 1, wherein the at least one of the one or more health risks, the one or more biometric parameters, or the one or more biomedical parameters are reported to the one or more participants in one or more forms comprising numerically, graphically, verbally, telephonically, electronically, or textually.

32. The method of claim 31, wherein the reported one or more health risks, the one or more biometric parameters, or the one or more biomedical parameters are compared to a medical index of normal range for the one or more health risks, the one or more biometric parameters, or the one or more biomedical parameters.

33. The method of claim 1, wherein the one or more participants are alerted when the one or more health risks, the one or more biometric parameters, or the one or more biomedical parameter falls outside a medical index of normal range for the one or more health risks, the one or more biometric parameters, or the one or more biomedical parameters.

34. The method of claim 33, wherein the one or more participants are informed of at least one of: one or more health risks associated with the health risk, the biometric parameter, or the biomedical parameter falling outside the medical index of normal range; that it is advisable to counsel one or more physicians regarding the health risk, the biometric parameter, or the biomedical parameter falling outside the medical index of normal range; one or more tests that can be used to determine the cause of the health risk, the biometric parameter, or the biomedical parameter falling outside the medical index of normal range; one or more tests that can be used to determine treatment for the health risk, the biometric parameter, or the biomedical parameter falling outside the medical index of normal range; one or more pharmacological agents that can assist in bringing the health risk, the biometric parameter, or the biomedical parameter falling outside the medical index of normal range substantially into normal range; one or more behavioral changes that can assist in bringing the health risk, the biometric parameter, or the biomedical parameter falling outside the medical index of normal range substantially into normal range; or one or more dietary changes that can assist in bringing the health risk, the biometric parameter, or the biomedical parameter falling outside the medical index of normal range substantially into normal range.

35. The method of claim 34, wherein the pharmacological agent comprises a prescription drug, an over-the-counter drug, a homeopathic agent, an herbal agent, a mineral, or a vitamin.

36. The method of claim 33, further comprising offering to the one or more alerted participants to treat the health risk, the biometric parameter, or the biomedical parameter at least one of a doctor prescribed prescription pharmacological agent, a doctor prescribed prescription to a pharmacological agent, an over-the-counter pharmacological agent, a homeopathic agent, an herbal agent, a mineral, a vitamin, an exercise program, a lifestyle regimen, a dietary program, or information regarding health effects of the health risk, the biometric parameter, or the biomedical parameter that falls outside the medical index of normal range.

37. The method of claim 33, wherein the health risk, the biometric parameter, or the biomedical parameter are explained to the one or more participants in relation to at least one of the participant's health or relevance to a health-risk behavior.

38. The method of claim 1, further comprising offering to the one or more participants to improve their Health Score an incentive to consume items that are lower or higher in at least one of salt, calories, carbohydrates, protein, fat, cholesterol, or triglycerides.

39. The method of claim 1, wherein the health risk assessment questionnaire assesses at least one of tobacco use, blood pressure, body weight, body fat, or body-mass-index of the one or more participants.

40. The method of claim 1, wherein the step of completing the health risk assessment questionnaire or the biometric measurement analysis or providing the biosample for biomedical analysis is for the purpose of categorizing the participant under assessment for purposes of enrollment in a clinical trial, on the basis of the health risks results, the biometric parameters results, or biomedical results.

41. The method of claim 1, wherein the step of completing the health risk assessment questionnaire or the biometric measurement analysis or providing the biosample for biometric analysis is for the purpose of categorizing the participant under assessment for purposes of suggesting a type of therapeutic treatment on the basis of the health risks results, the biometric parameters results, or biomedical results.

42. The method of claim 1 further comprising means for accessing the health care program over the Internet.

43. The method of claim 1, wherein a means for communicating is implemented via a network configured to interface over the Internet between the one or more participants and the health care program.

44. The method of claim 1, wherein the participant consents to allowing a manager of the health care program, or an affiliate or subcontractor thereof, to use information collected in conjunction with the health care program to generate at least one of a group report, a daily report, a weekly report, a monthly report, a bimonthly report, a quarterly report, a biannual report, an annual report, a group comparison, a daily comparison, a weekly comparison, a monthly comparison, a bimonthly comparison, a quarterly comparison, a biannual comparison, or an annual comparison for use by at least one of the manager of the health care program, a sponsor of the health care program, a benefit broker, a consultant, or an industry publication.

45. The method of claim 44, wherein the at least one reports or comparisons comprise aggregate information.

46. The method of claim 45, wherein the aggregate information does not contain data that identifying an individual participant.

47. The method of claim 1, wherein the information collected from the one or more participants in conjunction with the health care program is communicated to at least one of a coach or a health care practitioner to at least one of assist the participant in at least one of achieving, maintaining, or improving a Health Score; assist in monitoring the health of the participant; or assist in instructing the participant in regard to the information.

48. The method of claim 47, wherein the information communicated to the at least one coach or health care practitioner is done with consent of the participant.

49. The method of claim 47, wherein the health care practitioner comprises a nurse, a medical doctor's assistant, a medical doctor, a chiropractor, a psychologist, a social worker, a psychiatrist, a physical therapist, a massage therapist, a acupuncturist, a dietitian, or a physical trainer.

50. The method of claim 1, wherein the biosample comprises a blood, tissue, organ, saliva, hair, skin, fingernail, toenail, urine, or stool sample.

51. A computer program product for use with a system for managing an incentive based health care program, comprising: a computer usable medium having program code embodied in the medium for causing the computer program to interface over a communications medium between a sponsor of the health care program and one or more participants of the health care program, wherein the program code: performs at least one of offers to the one or more participants a health risk assessment questionnaire addressing one or more health risks, recognizes analyzed or raw data from one or more biometric analyses, or recognizes analyzed or raw data from one or more biomedical analyses obtained from a biosample received from the one or more participants; evaluates at least one of the one or more health risks, the one or more biometric parameters, or the one or more biomedical parameters to calculate a Health Score to assess for presence or risk of disease; and notifies the one or more participants of the Health Score.

52. The product of claim 51, wherein the program code further accesses a database to determine an incentive based on the Health Score of the participant.
